(19) United States
(12) Patent Application Publication
(10) Pub. No.: US 2016/0098390 A1
(43) Pub. Date: Apr. 7, 2016

(54) COMMAND HISTORY ANALYSIS APPARATUS AND COMMAND HISTORY ANALYSIS METHOD

(71) Applicant: FUJITSU LIMITED, Kawasaki-shi (JP)

(72) Inventors: Shinya KITAJIMA, Shinagawa (JP); Tetsuya Uchiumi, Kawasaki (JP); Shinji Kikuchi, Yokohama (JP); Yasuhide Matsumoto, Kawasaki (JP)

(73) Assignee: Fujitsu Limited, Kawasaki-shi (JP)

(21) Appl. No.: 14/858,290

(22) Filed: Sep. 18, 2015

(30) Foreign Application Priority Data
Oct. 3, 2014 (JP) 2014-204394

(51) Int. Cl. G06F 17/27; G06F 17/30

(52) U.S. Cl. CPC G06F 17/2705; G06F 17/30539

(57) ABSTRACT

A computer obtains a command history and a plurality of file histories. The command history includes command logs of executed commands. The plurality of file histories each include timing information and a character string indicating a storage location of each file. The computer extracts key commands from the command history on basis of contents of the executed commands. The computer extracts first file histories corresponding to each of the key commands on basis of timing information included in a command log of each of the key commands and timing information included in the plurality of file histories. The computer stores the first file histories in association with a first key command corresponding to the first file histories. The computer selects characteristic words from first character strings included in the first file histories. The computer stores the characteristic words in association with the first key command.

### CROSS-REFERENCE TO RELATED APPLICATION

This application is based upon and claims the benefit of priority of the prior Japanese Patent Application No. 2014-204394, filed on Oct. 3, 2014, the entire contents of which are incorporated herein by reference.

### FIELD

The embodiment discussed herein is related to a command history analysis apparatus and a command history analysis method.

### BACKGROUND

Various types of technologies for automating operational management work of an information processing system including a plurality of information processing apparatuses have been proposed. The operational management work includes, for example, work for installing an operating system (OS) and a variety of types of software in the information processing apparatus, work for setting a variety of types of information in the information processing apparatus, monitoring work of the information processing system, and failure handling work.

Related techniques are disclosed in, for example, Japanese Laid-open Patent Publication No. 2010-15512 and Japanese Laid-open Patent Publication No. 2008-117029.

As an example of the technologies for automating operational management work, there is a technique of using a data file (hereinafter, referred to as a file as appropriate) including a plurality of instructions (also referred to as commands) for executing operational management work. A file including a plurality of commands for executing the operational management work is also referred to as an automation component. The automation component is created not only manually by developers, but also automatically by executing software, or the like. In the following description, a function realized by executing software may also be referred to as software in some cases.

The administrator of an information processing system that performs operational management work analyzes commands in the automation component, and selects a desired automation component. The administrator performs the operational management work by using the selected automation component and an automation component obtained by customizing the selected automation component.

For example, when selecting an automation component for performing automation of operational management work for specific software, the administrator analyzes commands in the automation component. In this analysis, the administrator identifies a command for the specific software. The command for the specific software is a command that instructs the specific software to execute a process. The administrator selects an automation component for performing automation of operational management work for the specific software, by identifying this command.

If there are a large number of automation components, it is difficult for the administrator to select an automation component for performing automation of operational management work for the specific software, by performing such analysis. In other words, it is difficult for the administrator to identify the command for the specific software, from the large number of automation components that are created.

### SUMMARY

According to an aspect of the present invention, provided is a command history analysis method. In the method, a computer obtains a command history and a plurality of file histories. The command history includes command logs of executed commands. The plurality of file histories each include timing information and a character string indicating a storage location of each file. The computer extracts key commands from the command history on basis of contents of the executed commands. The computer extracts first file histories corresponding to each of the key commands on basis of timing information included in a command log of each of the key commands and timing information included in the plurality of file histories. The computer stores the first file histories in association with a first key command corresponding to the first file histories. The computer selects characteristic words from first character strings included in the first file histories. The computer stores the characteristic words in association with the first key command.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an entire system according to the present embodiment;

FIG. 2 is a diagram illustrating a hardware configuration of a user terminal in FIG. 1;

FIG. 3 is a diagram illustrating a hardware configuration of a server in FIG. 1;

FIG. 4 is a diagram illustrating a hardware configuration of an analysis apparatus in FIG. 1;

FIG. 5 is a diagram illustrating a functional configuration of an analysis apparatus in FIG. 4 and a part of storage areas of a storage device in FIG. 4;

FIG. 6 is a diagram illustrating an operation flow of an analysis apparatus in FIG. 1;

FIG. 7 is a flowchart illustrating an operation flow of an analysis apparatus in FIG. 1;

FIG. 8 is a diagram illustrating a command log;

FIG. 9 is a table of command logs, which is stored in a command log storage area in FIG. 5;

FIG. 10 is a diagram illustrating file histories of files;

FIG. 11 is a table of file histories, which is stored in a file history storage area in FIG. 5;

FIG. 12 is a diagram illustrating creation of an automation component;

FIG. 13 is a first table of automation components, which is stored in an automation component storage area in FIG. 5;

FIG. 14 is a second table of automation components, which is stored in an automation component storage area in FIG. 5;

FIG. 15 is a flowchart illustrating an operation flow of extracting general-purpose commands in FIG. 6 and FIG. 7;

FIG. 16 is a table of general-purpose commands, which is stored in a general-purpose command storage area in FIG. 5;

FIG. 17 is a flowchart illustrating an operation flow of extracting common work commands in FIG. 6 and FIG. 7;

FIG. 18 is a table of common work commands, which is stored in a common work command storage area in FIG. 5;

FIG. 19 is a diagram illustrating association between a key command and a file history;

FIG. 20 is a table of associations between a command log of a key command and a file history;

FIG. 21 is a diagram illustrating a state in which a key command is stored in association with a plurality of file histories;

FIG. 22 is a table of associations between a key command and a file path thereof, which is stored in a selected path storage area in FIG. 5;

FIG. 23 is a flowchart illustrating an operation flow of selecting a characteristic word in FIG. 6 and FIG. 7;

FIG. 24 is a diagram illustrating selection of a characteristic word;

FIG. 25 is a first table of associations between a key command and a characteristic word thereof, which is stored in an automation component storage area in FIG. 5;

FIG. 26 is a second table of associations between a key command and a characteristic word thereof, which is stored in an automation component storage area in FIG. 5; and

FIGS. 27A and 27B are diagrams illustrating search for an automation component.

### DESCRIPTION OF EMBODIMENT

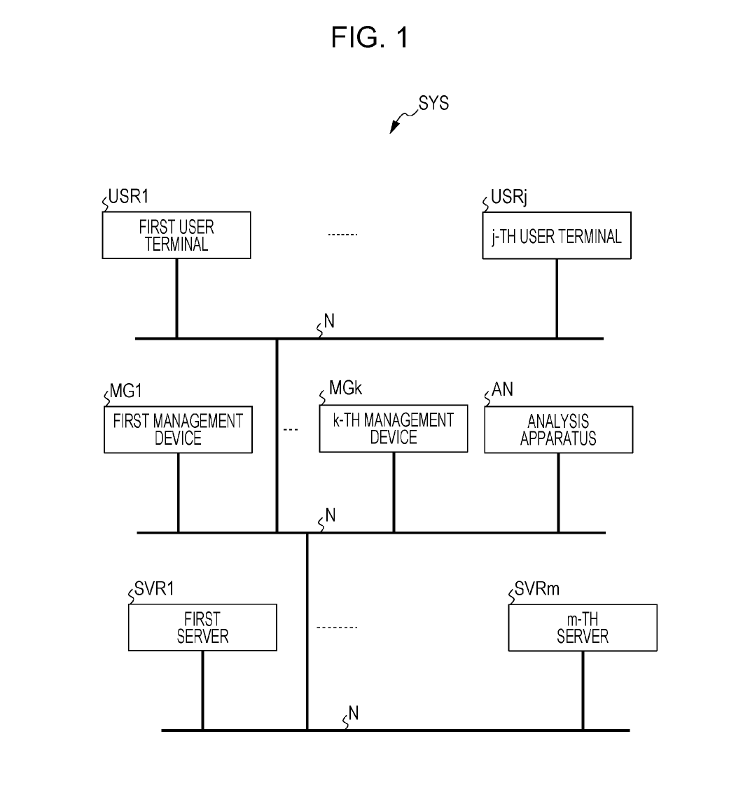

FIG. 1 is a diagram illustrating an entire system according to the present embodiment. In the following description, similar elements will be assigned with similar reference numerals, and a repetitive description will be omitted.

An information processing system SYS is, for example, a cloud system, and provides various types of information processing to a user while being connected to a large-scale network such as the Internet (not illustrated). The information processing system SYS is installed in, for example, a data center or the like.

The information processing system SYS includes a first user terminal USR1 to a j-th user terminal USRj (j is an integer of 2 or more), and a first management device MG1 to a k-th management device MGk (k is an integer of 2 or more). The information processing system SYS also includes an analysis apparatus AN, and a first server SVR1 to an m-th server SVRm (m is an integer of 2 or more). Dotted lines in FIG. 1 indicate that user terminals, management devices, and servers are omitted.

The first user terminal USR1 to the j-th user terminal USRj, the first management device MG1 to the k-th management device MGk, the analysis apparatus AN, and the first server SVR1 to the m-th server SVRm are connected to each other through a network N denoted by a thick line.

The first management device MG1 to the k-th management device MGk are devices that manage the information processing system SYS. The first management device MG1 to the k-th management device MGk obtain, for example, result logs indicating processing results that the first server SVR1 to the m-th server SVRm sequentially output. A log is also referred to as a record. If an abnormal log indicating abnormality occurring in a server is included in the obtained result logs, the first management device MG1 to the k-th management device MGk notify the administrator of the information processing system SYS (hereinafter, referred to as an administrator as appropriate) of the occurrence of abnormality.

The analysis apparatus AN creates automation components. The analysis apparatus AN also performs processing for identifying a command for specific software, by referring to a command log (also referred to as a command history) and a file history indicating a history of processing on a file including data. A command (hereinafter, referred to as a key command as appropriate) for specific software is a command instructing the specific software to execute a process. This process includes, for example, various processes such as an instruction for executing data processing. The specific software is, for example, various types of development software, calculation software, data analysis software, or software for monitoring an information processing system. The analysis apparatus AN is also referred to as a command history analysis apparatus.

The command log includes contents and timing information about an executed command. The timing information included in the command log includes a timing when the command is executed. The file history includes a file path of a file and timing information about the file. The timing information included in the file history includes a timing when the file is created and a timing when the contents of the file are changed.

The first user terminal USR1 to the j-th user terminal USRj issue various commands to the operating system or application software that is executed by servers or management devices, by using terminal software through the operation of the administrator. The servers are the first server SVR1 to the m-th server SVRm, and the management devices are the first management device MG1 to the k-th management device MGk. The first user terminal USR1 to the j-th user terminal USRj also issue various commands to the operating system or application software that is executed by the analysis apparatus AN through the operation of the administrator.

The first server SVR1 to the m-th server SVRm are information processing apparatuses each of which provides various information processing to the user. If the information processing system SYS is a cloud system, the user is a user of the cloud system. The first server SVR1 to the m-th server SVRm provide various types of information processing by running, for example, a virtual machine.

As an example of a technique of automating operational management work, there is a technique of using an automation component including a plurality of commands. The automation component is, for example, a file that is described in a text format. Such a file is referred to as a script file or a batch file. Objects for automating operational management work include, for example, first and second objects. The first object is to reduce the number of steps of the operational management work by automating identical works as much as possible. The second object is to reduce erroneous operations by reducing manual works.

The administrator selects an automation component for performing automation of operational management work for specific software, from among automation components which are stored in the analysis apparatus AN. In this case, the administrator analyzes commands in the automation component. The administrator identifies a command for the specific software in this analysis. The administrator selects an automation component for performing automation of operational management work for the specific software.

The administrator intends to improve the efficiency of the operational management work by reusing or customizing the selected automation component. However, if there are a large number of automation components, it is difficult for the administrator to select an automation component for performing automation of operational management work for the specific software, by performing such analysis. In particular, if an automation component contains a command making a request to another automation component (so-called, a nest of a file), it is difficult for the administrator to select a desired automation component.

Therefore, the analysis apparatus AN according to the present embodiment identifies a command for specific software from a command log, by referring to the command log and a file history. Then, the analysis apparatus AN sets a tag in the identified command, and facilitates identification of the command.

The administrator may easily identify a command for the specific software, by this tag. The administrator may also easily identify an automation component including the command for the specific software.

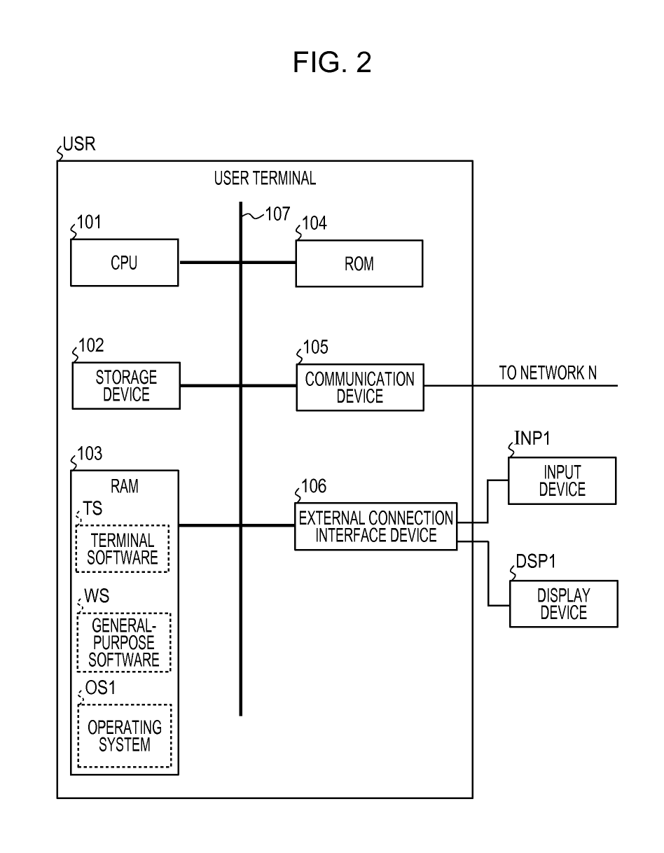

FIG. 2 is a diagram illustrating a hardware configuration of the user terminal in FIG. 1. A user terminal USR in FIG. 2 is any of a first user terminal USR1 to the j-th user terminal USRj.

The user terminal USR includes a central processing unit (CPU) 101, a storage device 102, a random access memory (RAM) 103, a read-only memory (ROM) 104, a communication device 105, and an external connection interface device 106, all of which are connected to a bus 107.

The CPU 101 is a central processing unit that controls the user terminal USR. The storage device 102 is a storage device capable of storing therein data of a large capacity, and is, for example, a large-capacity storage device such as a hard disk drive (HDD) or a solid state drive (SSD). The storage device 102 stores therein executable files (programs) of terminal software TS, general-purpose software WS, and an operating system OS1, and command logs, which will be described later.

The RAM 103 temporarily stores therein a plurality of pieces of data which are generated in a process executed by the CPU 101, or at respective steps that the terminal software TS and the general-purpose software WS execute. The RAM 103 is, for example, a semiconductor memory such as a dynamic random access memory (DRAM).

The CPU 101 reads the executable files of the terminal software TS, the general-purpose software WS, and the operating system OS1, from the storage device 102, at the start of the user terminal USR, and transfers the files to the RAM 103. FIG. 2 illustrates a state in which the CPU 101 transfers the terminal software TS, the general-purpose software WS, and the operating system OS1, to the RAM 103.

The terminal software TS is software that performs processing for receiving various commands, or displays and outputs the execution result of executing various commands. The terminal software TS stores the contents of the input command, an execution timing of the command, and the result of executing the command in the storage device 102, as a command log. The terminal software TS is, for example, software such as “TERA TERM” and “PuTTY”.

The general-purpose software WS performs various general-purpose information processing such as information retrieval. The operating system OS1 is an operating system such as UNIX (registered trademark) or Windows (registered trademark).

The ROM 104 stores therein a variety of types of configuration information. The communication device 105 includes, for example, a network interface card (NIC), and is connected to the network N through a local area network (LAN) cable to perform communication.

The external connection interface device 106 is a device that functions as an interface for connection with various external devices. The external connection interface device 106 includes, for example, a card slot and a port of a universal serial bus (USB).

The external connection interface device 106 is connected to an input device INP1 and a display device DSP1.

The input device INP1 is a device that inputs operation information to the user terminal USR. The input device INP1 is, for example, a keyboard or a mouse. The display device DSP1 is a device that displays a variety of types of information such as images and characters that the user terminal USR outputs. The display device DSP1 is, for example, a liquid crystal display.

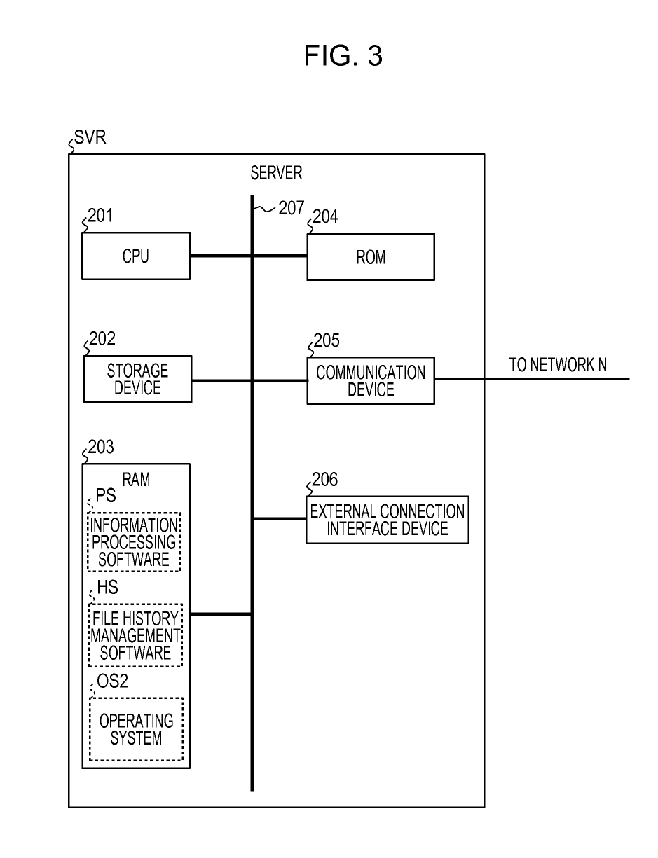

FIG. 3 is a diagram illustrating a hardware configuration of the server in FIG. 1. The server SVR in FIG. 3 is any of the first server SVR1 to the m-th server SVRm.

The server SVR includes a CPU 201, a storage device 202, a RAM 203, a ROM 204, a communication device 205, and an external connection interface device 206, all of which are connected to a bus 207.

The CPU 201 is a central processing unit that controls the server SVR. The storage device 202 is a storage device capable of storing therein data of a large capacity, and is, for example, a large-capacity storage device such as an HDD or an SSD. The storage device 202 stores therein executable files (programs) of information processing software PS, file history management software HS, and an operating system OS2, and various files, which will be described later.

The RAM 203 temporarily stores therein a plurality of pieces of data which are generated in a process executed by the CPU 201, or at respective steps that the information processing software PS, the file history management software HS, and the operating system OS2 execute. The RAM 203 is, for example, a semiconductor memory such as a DRAM.

The CPU 201 reads the executable files of the information processing software PS, the file history management software HS, and the operating system OS2, from the storage device 202, at the start of the server SVR, and transfers the files to the RAM 203. FIG. 3 illustrates a state in which the CPU 201 transfers the information processing software PS, the file history management software HS, and the operating system OS2 to the RAM 203.

The information processing software PS is software that performs various information processing. The information processing software PS is, for example, various types of software such as virtualization software, virtual machines that are operated by the virtualization software, and various applications.

The file history management software HS is software that manages a history of a file that is created, updated, or deleted by executing the information processing software PS. The file is stored in the storage device 202. The file history management software HS is, for example, software such as a Concurrent Versions System (CVS) that manages the file history.

The ROM 204 stores therein a variety of types of configuration information. The communication device 205 includes, for example, a NIC, and is connected to the network N through a LAN cable to perform communication. The external connection interface device 206 is a device that functions as an interface for connection with various external devices. The external connection interface device 206 includes for example, a card slot and a port of a USB.

The first management device MG1 to the k-th management device MGk in FIG. 1 also have similar hardware configuration as of the server SVR. In the case of the first management device MG1 to the k-th management device MGk, the information processing software PS is software that performs various types of processing for operational management work on the first server SVR1 to the m-th server SVRm.

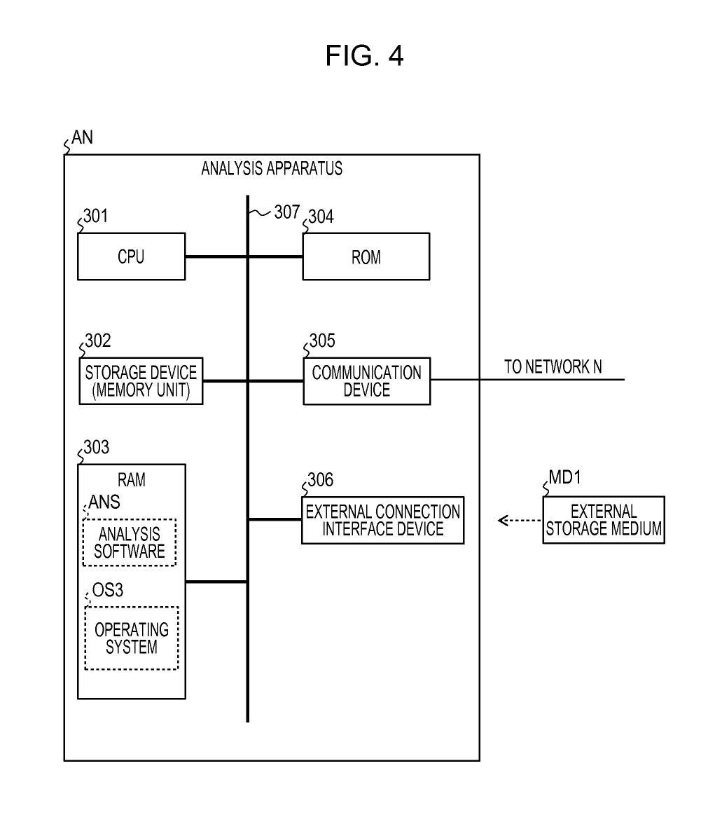

FIG. 4 is a diagram illustrating a hardware configuration of the analysis apparatus AN in FIG. 1. The analysis apparatus AN is an information processing apparatus, and includes a CPU 301, a storage device (memory unit) 302, a RAM 303, a ROM 304, a communication device 305, and an external connection interface device 306, all of which are connected to a bus 307. Hereinafter, the storage device (memory unit) 302 is referred to as storage device 302 as appropriate.

The CPU 301 is a central processing unit that controls the analysis apparatus AN. The storage device 302 is a storage device capable of storing therein data of a large capacity, and is, for example, a large-capacity storage device such as an HDD or an SSD. The storage device 302 stores therein executable files (programs) of analysis software ANS that performs analysis of the command log and an operating system OS3, and various types of data.

The RAM 303 temporarily stores therein a plurality of pieces of data which are generated in a process executed by the CPU 301, or at respective steps that the analysis software ANS and the operating system OS3 execute. The RAM 303 is, for example, a semiconductor memory such as a DRAM.

The CPU 301 reads the executable files of the analysis software ANS and the operating system OS3, from the storage device 302, at the start of the analysis apparatus AN, and transfers the files to the RAM 303. FIG. 4 illustrates a state in which the CPU 301 transfers the analysis software ANS and the operating system OS3 to the RAM 303. The executable files may be stored in an external storage medium MD1.

The ROM 304 stores therein a variety of types of configuration information. The communication device 305 includes, for example, a NIC, and is connected to the network N through a LAN cable to perform communication.

The external connection interface device 306 is a device that functions as an interface for connection with the external storage medium MD1 and various external devices. The external connection interface device 306 includes for example, a card slot and a port of a USB.

The external storage medium MD1 is a portable non-volatile memory such as a USB memory. A storage medium reading device (not illustrated) that reads data stored in a storage medium may be connected to the external connection interface device 306. The storage medium (also referred to as a recording medium) is, for example, a portable storage medium such as a compact disc read-only memory (CD-ROM) and a digital versatile disc (DVD).

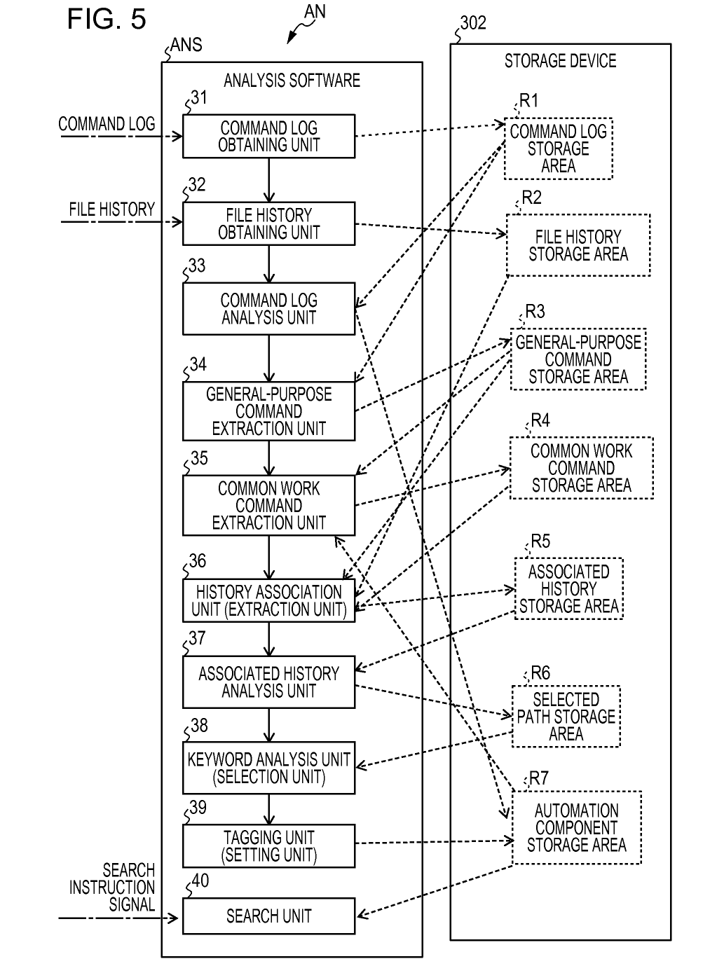

FIG. 5 illustrates a detailed functional configuration of the analysis software ANS in FIG. 4, and illustrates the configuration of a part of the storage areas of the storage device 302 in FIG. 4. In FIG. 5, solid line arrows indicate, for example, the operation flows between the functional units. Dashed line arrows indicate some of the data flows between the respective functional units and the respective storage areas in FIG. 5.

The analysis software ANS includes a command log obtaining unit 31, a file history obtaining unit 32, a command log analysis unit 33, a general-purpose command extraction unit 34, a common work command extraction unit 35, and a history association unit (extraction unit) 36. The history association unit (extraction unit) 36 is referred to as a history association unit 36 as appropriate. The analysis software ANS further includes an associated history analysis unit 37, a keyword analysis unit (selection unit) 38, a tagging unit (setting unit) 39, and a search unit 40. The keyword analysis unit (selection unit) 38 is referred to as a keyword analysis unit 38, and the tagging unit (setting unit) 39 is referred to as a tagging unit 39 as appropriate.

The command log obtaining unit 31 obtains a command log from the server SVR and the user terminal USR. The file history obtaining unit 32 obtains a file history indicating a history of processing on a file from the server SVR or the like. The command log analysis unit 33 analyzes the obtained command log, and creates an automation component. The general-purpose command extraction unit 34 extracts a general-purpose command including contents of a command for general use from among a plurality of command logs, based on an occurrence frequency of a command. The common work command extraction unit 35 extracts a common command (hereinafter, referred to as a common work command as appropriate) including contents of a command that is common to two or more automation components from among a plurality of command logs, based on an occurrence frequency of a command.

The history association unit 36 stores a key command and a file history corresponding to the key command in association with each other, in the storage device 302. A description about the file history corresponding to the key command will be given in the following description about the selection of the file history. The associated history analysis unit 37 analyzes the associated file history, and extracts a file path of the key command.

The keyword analysis unit 38 performs keyword analysis of the file path, and selects a characteristic word from among the words that are included in the file path. The tagging unit 39 sets a characteristic word as a tag for the key command. The search unit 40 searches, upon receiving a search instruction signal, for a key command for which a search target word (in other words, a characteristic word) included in the search instruction signal is set.

The storage device 302 includes a command log storage area R1, a file history storage area R2, a general-purpose command storage area R3, a common work command storage area R4, an associated history storage area R5, a selected path storage area R6, and an automation component storage area R7. The respective storage areas R1 to R7 are indicated by dotted lines.

The command log storage area R1 is an area for storing a command log. The file history storage area R2 is an area for storing a file history. The general-purpose command storage area R3 is an area for storing a general-purpose command. The common work command storage area R4 is an area for storing a common work command.

The associated history storage area R5 is an area for storing a key command and a file history in association with each other. The selected path storage area R6 is an area for storing a key command and a file path of the key command in association with each other. The automation component storage area R7 is an area for storing an automation component.

The respective functional units 31 to 40 are accessible to the respective storage areas R1 to R7. The data stored in the respective storage areas R1 to R7 of the storage device 302 may be stored in other storage devices such as a storage server.

Processing in the analysis apparatus AN will be described. Hereinafter, the first user terminal USR1 to the j-th user terminal USRj, the first management device MG1 to the k-th management device MGk, and the first server SVR1 to the m-th server SVRm are simply collectively referred to as processing apparatuses. When a processing apparatus executes an input command, a file is created and stored in the storage, contents of the file stored in the storage are updated, or the file stored in the storage is removed. Hereinafter, any of creation of a file, update of contents of a file, and deletion of a file is referred to as change of a file as appropriate.

A storage location of a file may be identified by a character string (also referred to as a file path) indicating the storage location of the file in a storage device. A file path of a file is represented in a hierarchical structure of folders, and the file is stored in a folder in the lowest layer. A file path includes a name of a file and names of folders in which the file is stored. The file path further includes a symbol that separates names of two folders from each other, and a symbol that separates a name of a folder and the name of the file.

This symbol is, for example, “/” (slash) or “\” (backslash). For example, file path “var/opt/middle A/service.conf” indicates a folder name “var”, a folder name “opt”, a folder name “middle A”, and a file name “service”. The file of the file name “service” is stored in the folder of the folder name “middle A”. The character string (for example, “conf”) following “.” (dot) is referred to as an extension.

In general, a file associated with specific software is often stored under a folder of a name associated with this specific software in many cases. Further, a file name of a configuration file and the like are often includes the name of the specific software and the like.

The analysis apparatus AN extracts a key command for specific software, and selects a word associated with the specific software as a characteristic word, from a file path of a file history corresponding to the key command. The analysis apparatus AN associates and stores the key command and the characteristic word of this key command.

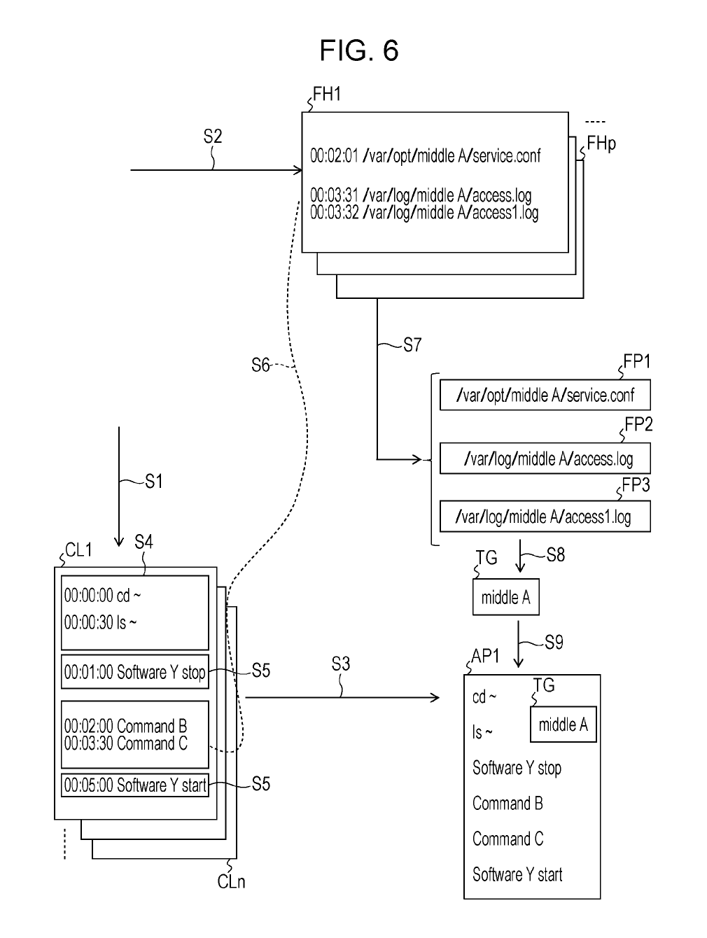

An operation flow executed by the analysis apparatus AN according to the present embodiment will be described with reference to FIG. 6 and FIG. 7. FIG. 6 is a diagram illustrating an operation flow of the analysis apparatus AN in FIG. 1. FIG. 7 is a flowchart illustrating the operation flow of the analysis apparatus AN in FIG. 1.

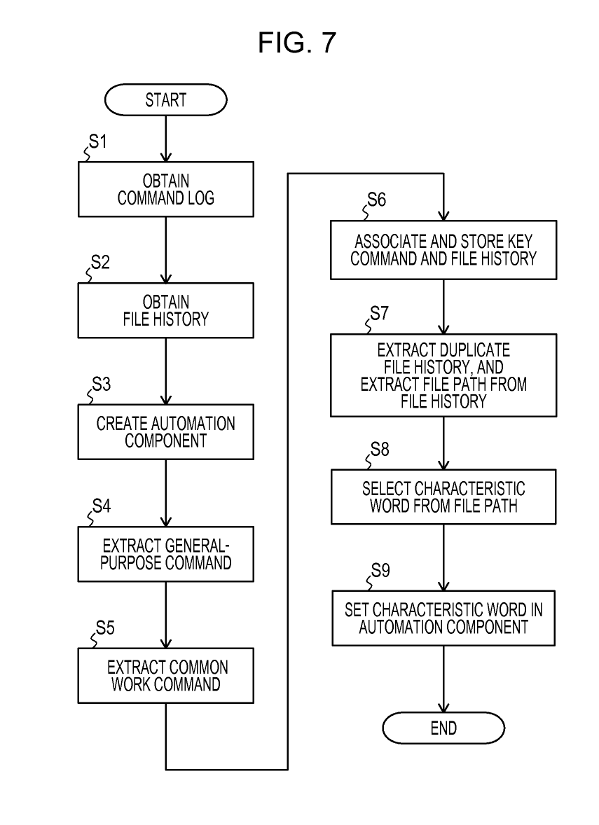

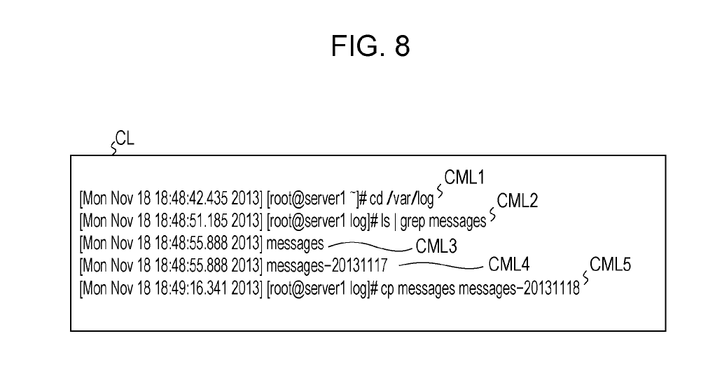

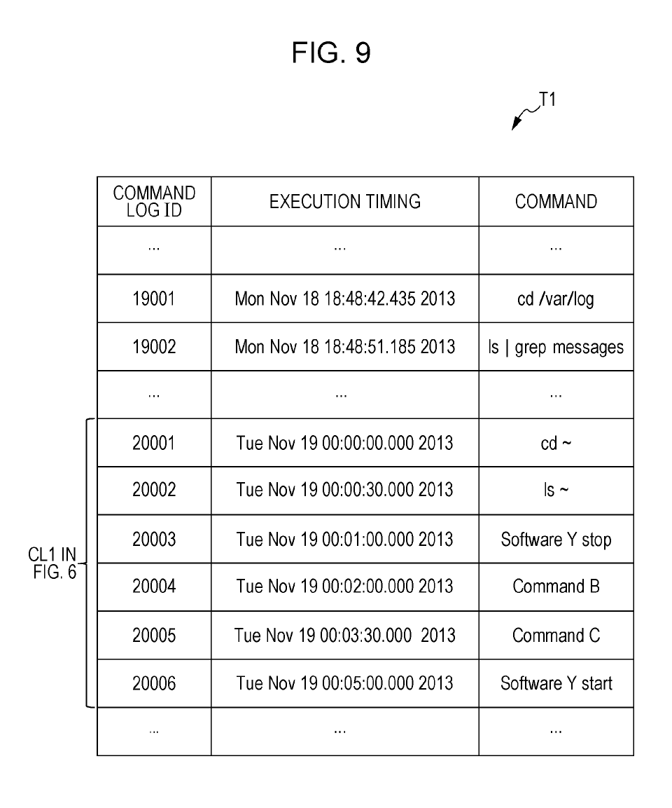

S1: The command log obtaining unit 31 obtains command logs of commands that are executed in other terminals or other devices, from the other terminals or the other devices. In the example in FIG. 6, the command log obtaining unit 31 obtains a first command log group CL1 to an n-th command log group CLn (n is an integer of 2 or more). A command log group includes a plurality of command logs. The command log obtaining unit 31 stores the obtained command logs in the command log storage area R1 in FIG. 5. The other terminals are, for example, the first user terminal USR1 to the j-th user terminal USRj in FIG. 1. The other devices are, for example, the first management device MG1 to the k-th management device MGk in FIG. 1 and the first server SVR1 to the m-th server SVRm in FIG. 1. The details about S1 will be described with reference to FIG. 8 and FIG. 9.

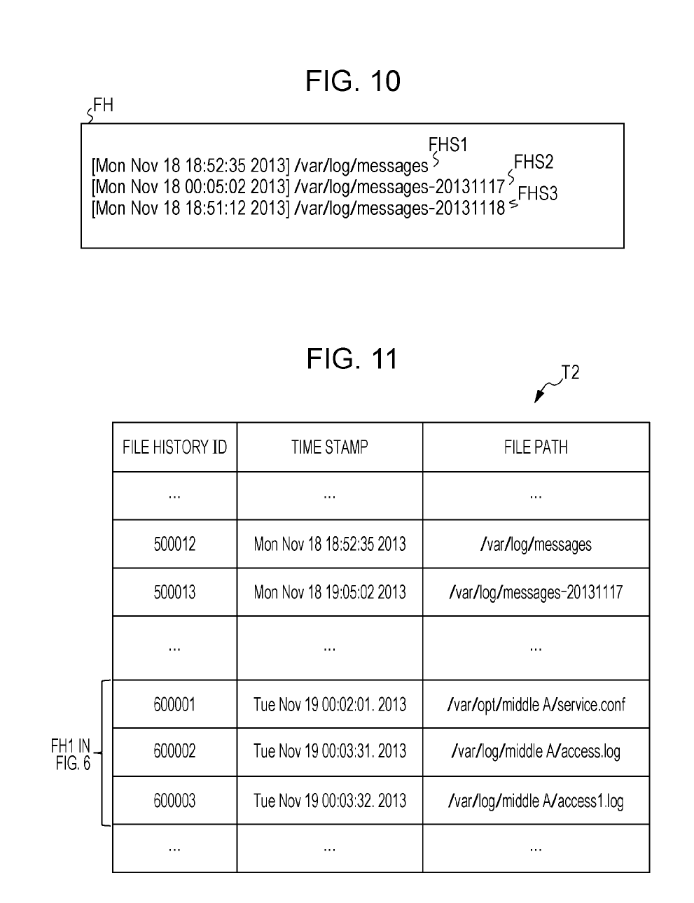

S2: The file history obtaining unit 32 obtains file histories of files from the other devices. In the example of FIG. 6, the file history obtaining unit 32 obtains a first file history group FH1 to the p-th file history group FHp (p is an integer of 2 or more). The file history obtaining unit 32 stores the obtained file histories in the file history storage area R2. The details about S2 will be described with reference to FIG. 10 and FIG. 11.

If different operating systems are running on each terminal, each server, and each device, in general, commands for executing similar contents are different depending on the operating system. Therefore, if different operating systems are running on each terminal, each server, and each device, the analysis apparatus AN obtains command logs and file histories, from terminals, servers, and devices in which an identical operating system is running, and executes S3 and after. In the following description, it is assumed that operating system running on each terminal, each server, and each device is identical.

S3: The command log analysis unit 33 analyzes the obtained command logs, and creates an automation component. The automation component includes a series of commands that are included in the command logs and automatically execute predetermined processes. The command log analysis unit 33 stores the created automation component in the automation component storage area R7. In the example of FIG. 6, the command log analysis unit 33 creates an automation component AP1. The details about S3 will be described with reference to FIG. 12.

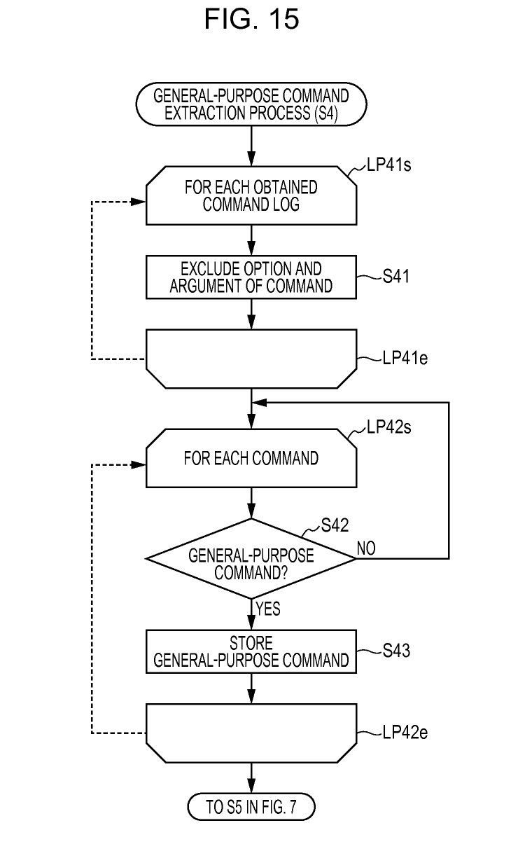

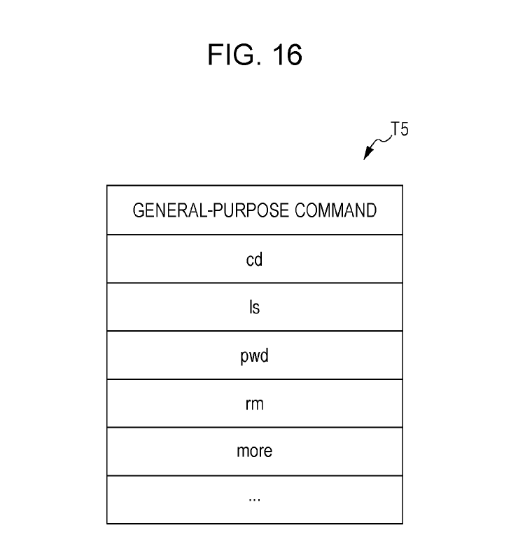

S4: The general-purpose command extraction unit 34 extracts a general-purpose command including contents of a command for general use, based on the occurrence frequency of commands, from the obtained command logs, and stores the extracted general-purpose command in the general-purpose command storage area R3. The details about S4 will be described with reference to FIG. 15 and FIG. 16.

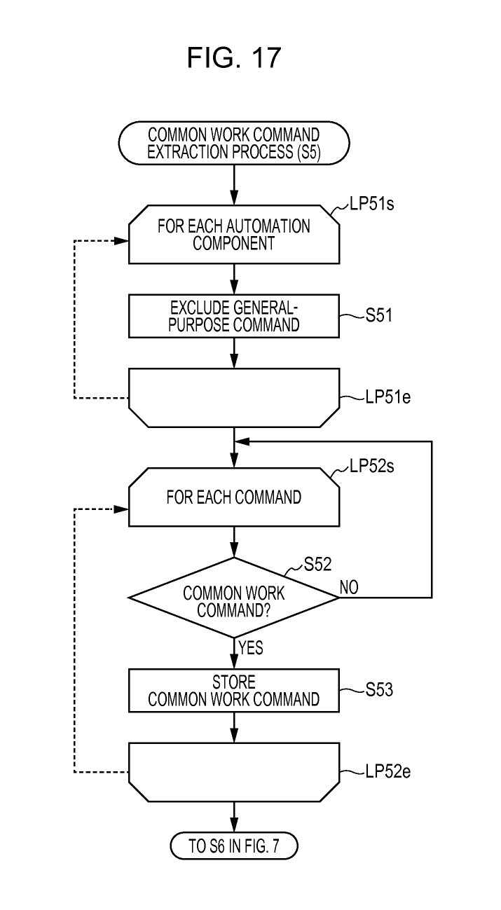

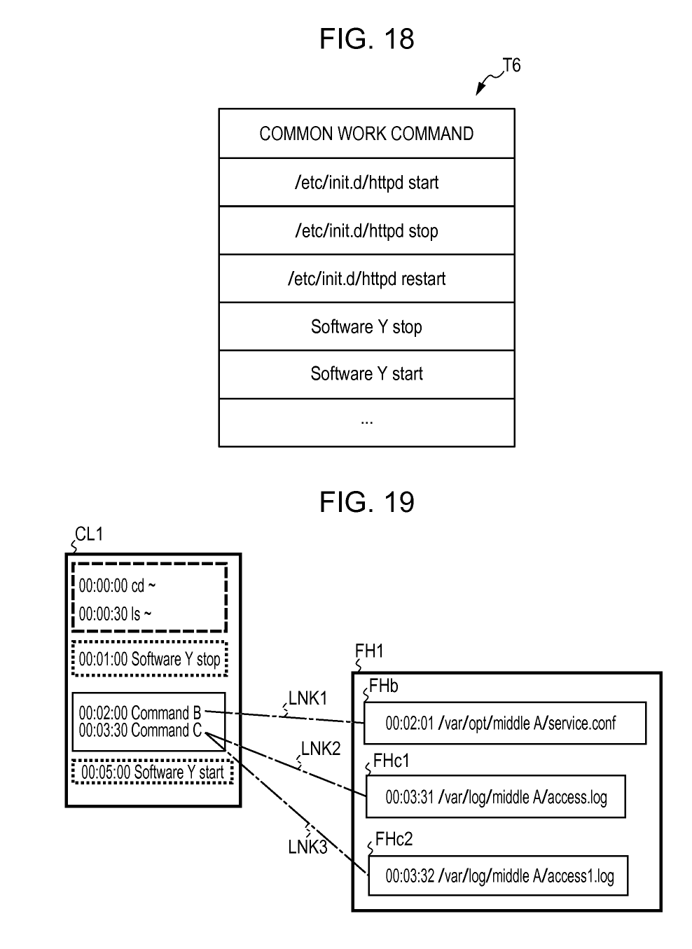

S5: The common work command extraction unit 35 obtains automation components from the automation component storage area R7, and extracts a common command including contents of a command which is common to two or more automation components, based on the occurrence frequency of commands, from among the obtained automation components. Then, the common work command extraction unit 35 stores the extracted common command (hereinafter, referred to as a common work command as appropriate) in the common work command storage area R4. The details about S5 will be described with reference to FIG. 17 and FIG. 18.

S6: The history association unit 36 extracts a key command for specific software, from the command logs, based on the contents of the executed commands. The history association unit 36 extracts a file history corresponding to the extracted key command, based on timing information of the key command included in the command log of the extracted key command and timing information included in the file history.

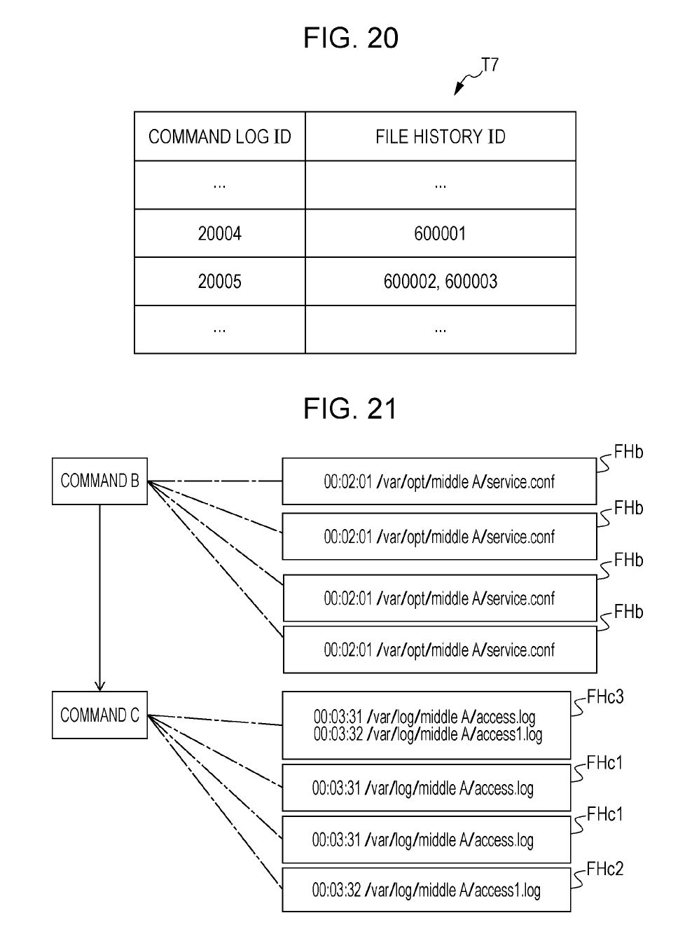

Then, the history association unit 36 associates (in other words, links) and stores the key command and the file history corresponding to the key command, in the associated history storage area R5. In the extraction of the key commands, the history association unit 36 extracts, as the key commands, commands obtained by excluding the extracted general-purpose commands and the extracted common work commands from among the commands included in the automation component. The commands included in the automation component include some of the commands corresponding to the command logs extracted in S1. The details about S6 will be described with reference to FIG. 19 and FIG. 20. In the example of FIG. 6, the key commands are command B and command C (see FIG. 6). In the example of FIG. 6, the association is indicated by a dotted line. The command B and the command C are key commands instructing specific software to execute a process. Hereinafter, the command B and the command C are respectively referred to as a key command B and a key command C, as appropriate.

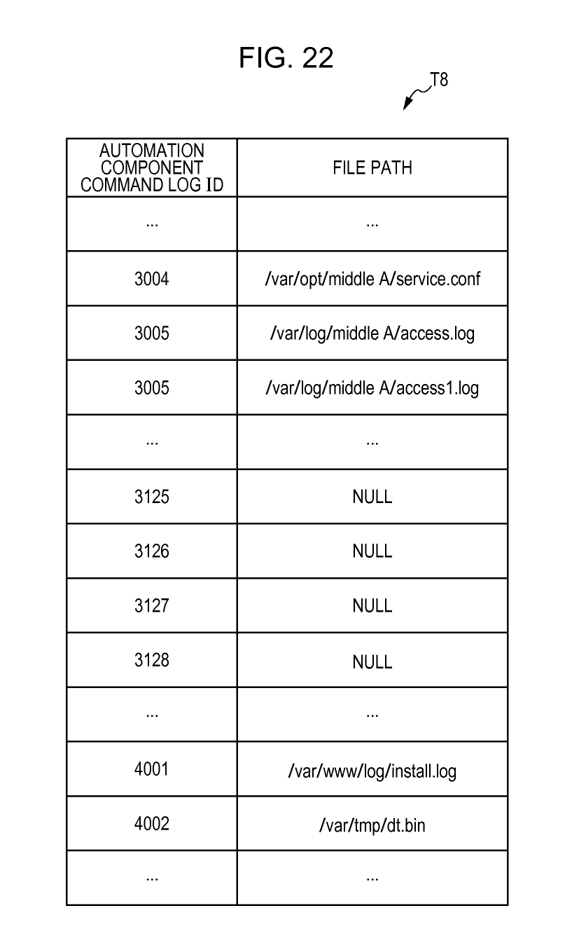

S7: The associated history analysis unit 37 analyzes the associated file histories, and extracts duplicate file history from the associated file histories. The associated history analysis unit 37 also extracts file paths from the associated file histories. In the example of FIG. 6, the associated history analysis unit 37 extracts file paths FP1 to FP3. The details about S7 will be described with reference to FIG. 21 and FIG. 22.

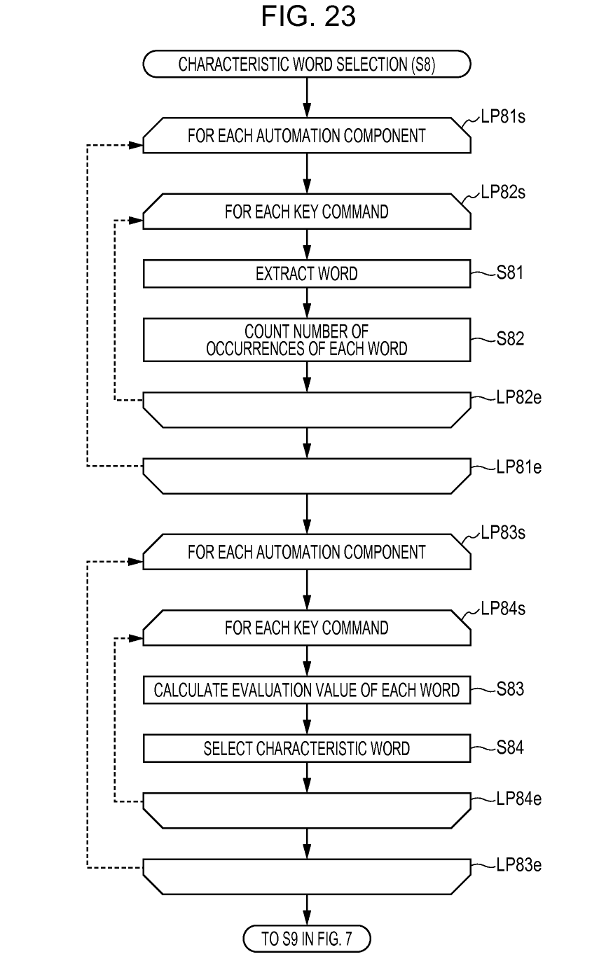

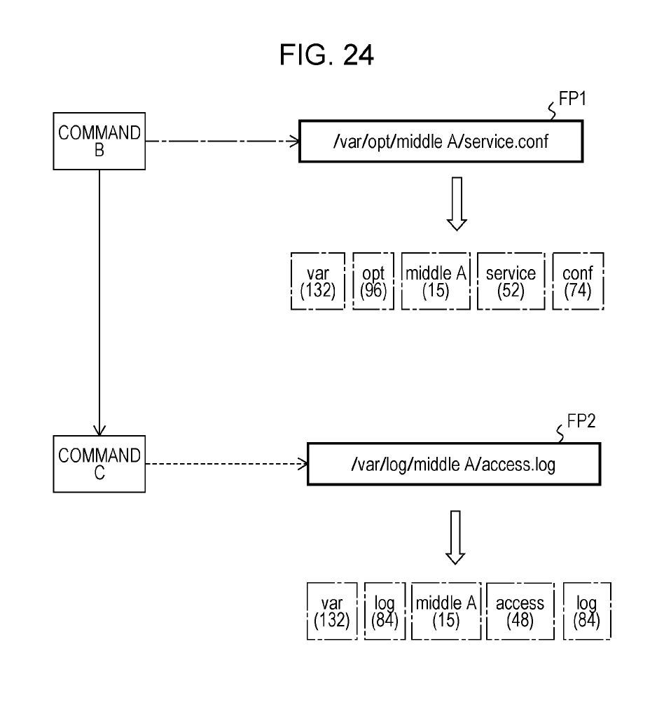

S8: The keyword analysis unit 38 performs a keyword analysis of the file paths extracted in S7, and selects characteristic words from among the words included in the file paths. In the example of FIG. 6, the keyword analysis unit 38 selects “middle A” (see a tag TG) as a characteristic word. The details about S8 will be described with reference to FIG. 23 and FIG. 24.

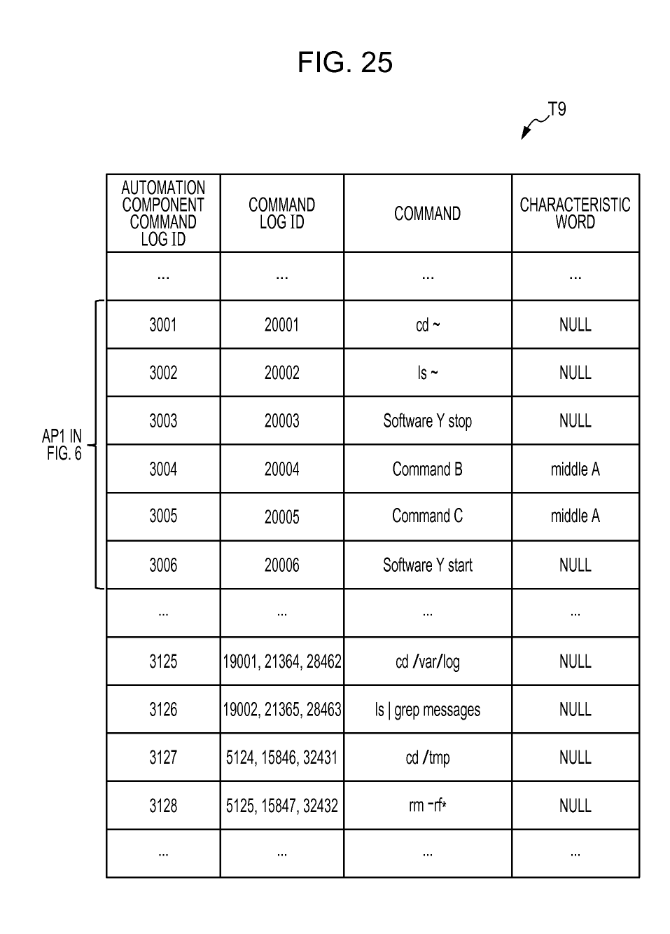

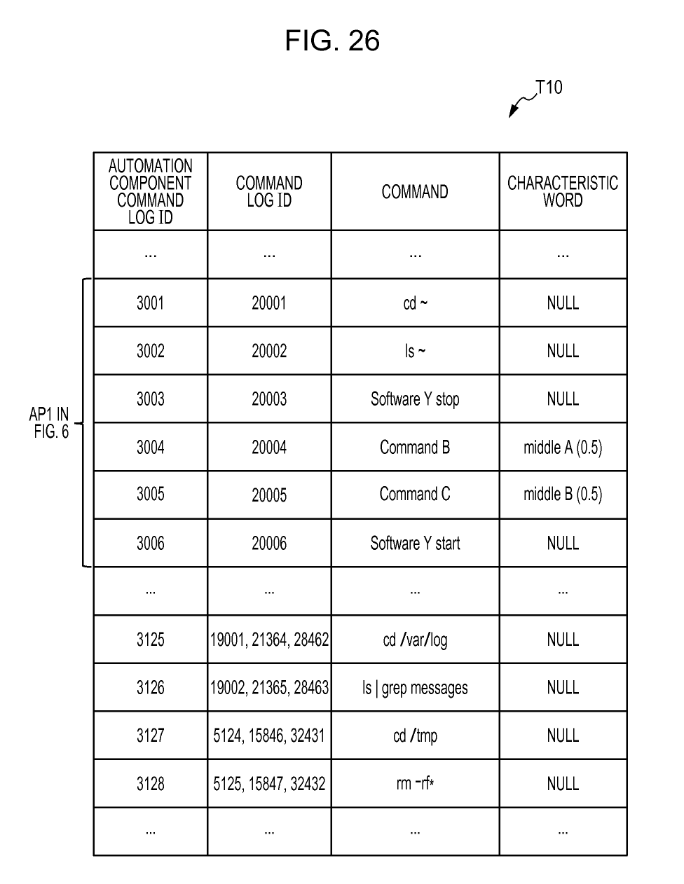

S9: The tagging unit 39 associates and stores the key command extracted in S6 and the characteristic word selected in S8. Specifically, the tagging unit 39 sets the characteristic word as a tag in the automation component including the key command extracted in S6. In the example of FIG. 6, the key commands are command B and command C, the automation component is the automation component AP1, and the tag that is set is a tag TG. The details about S9 will be described with reference to FIG. 25 and FIG. 26.

Next, the acquisition of the command log in S1 of FIG. 6 and FIG. 7 will be described with reference to FIG. 8 and FIG. 9. The administrator accesses the first management device MG1 to the k-th management device MGk in FIG. 1 and the first server SVR1 to the m-th server SVRm in FIG. 1 through the terminal software TS, by operating the input device INP1 of the user terminal USR in FIG. 2.

For example, the administrator inputs, to the terminal software TS, a command for performing operational management work for the server SVR. The terminal software TS transmits the command to the server SVR, and stores a command log (see FIG. 8) in the storage device 102.

The information processing software PS of the server SVR receives the command, and executes a process corresponding to the received command. The information processing software PS transmits a result of processing (hereinafter, referred to as a processing result as appropriate) to the terminal software TS installed in the user terminal USR. The terminal software TS receives the processing result, and displays it on the display device DSP1. The terminal software TS stores, as a command log, the processing result in the storage device 102.

FIG. 8 is a diagram illustrating a command log. A command log contains an execution timing of a command and contents of the executed command. The command log also includes a timing of a processing result and contents of the processing result. The timing of the processing result is, for example, the end timing of the process, or a timing in which the terminal software TS has received the processing result. The timing may include date, hour, minute, and second.

In FIG. 8, a command log group CL includes five command logs. In a command log, a character string in the first brackets “[ ]” from the left in FIG. 8 indicates an execution timing of a command or a timing of a processing result. For example, “[Mon Nov 18 18:48:42.435 2013]” of the first command log CML1 indicates an execution timing of the command. “[Mon Nov 18 18:48:42.435 2013]” is “18:48:42.435” (18 o'clock 48 minutes 42.435 seconds) on Monday (Mon) November (Nov.) 18th, in 2013.

A character string in the second brackets “[ ]” from the left in FIG. 8 indicates a file path of a current directory. The file path of the current directory is, for example, an absolute path. For example, [root@server1˜] of the first command log CML1 indicates that the file path of the current directory is the root folder of the first server SVR1.

A character string following the second brackets “[ ]” from the left in FIG. 8 indicates contents of the executed command or contents of the processing result.

A command “cd/var/log” of the first command log CML1 is a command to move to a directory “/var/log”. A command “Is| grep messages” of the second command log CML2 is a command to search for a file including a character string “messages” among files in the “log” folder. The third command log CML3 is a result of the search described above, and indicates that a “messages” file is found. The fourth command log CML4 is a result of the search described above, and indicates that a “messages-20131117” file is found. A command “cp messages messages-20131118” of the fifth command log CML5 is a command of the following contents. That is, this command is a command to create a file with a file name “messages-20131118” which is a copy of the “messages” file.

The terminal software TS of the user terminal USR creates the command log described above, and stores it in the storage device 102. If the operating system OS1 of the user terminal USR is UNIX (registered trademark), the administrator sets in advance that “script” command is to be executed after an input of a command. Then, the operating system OS1 of the user terminal USR stores the log of the input command and the log of the processing result in the storage device 102.

The command log obtaining unit 31 of the analysis apparatus AN requests the first user terminal USR1 to the j-th user terminal USRj to transmit command logs. The general-purpose software WS of the first user terminal USR1 to the j-th user terminal USRj transmits the command log stored in the storage device 102 to the analysis apparatus AN, in response to this request. The command log obtaining unit 31 of the analysis apparatus AN receives the command log and allocates, to the received command log, an identifier (ID) for identifying the received command log. The command log obtaining unit 31 associates and stores the received command log and the identifier of the received command log, in the command log storage area R1.

As a method of obtaining a command log, there are other various methods in addition thereto. For example, a case is assumed in which the operating system OS of the first server SVR1 to the m-th server SVRm is UNIX (registered trademark). In this case, the command log obtaining unit 31 of the analysis apparatus AN transmits, to the first server SVR1 to the m-th server SVRm, a “history” command for displaying a command log. Upon receiving this command, the operating system OS of the first server SVR1 to the m-th server SVRm transmits the command log to the command log obtaining unit 31 of the analysis apparatus AN in response to this command. The command log obtaining unit 31 receives the command log, and stores it in the command log storage area R1.

In the example of FIG. 6, the first command log group CL1 includes a command log “00:00:00 cd˜”, a command log “00:00:30 Is˜”, a command log “00:01:00 software Y stop”, and a command log “00:02:00 command B”. The first command log group CL1 further includes a command log “00:03:30 command C”, and a command log “00:05:00 software Y start”.

The command log “00:00:00 cd˜” indicates that a command to move the directory to an argument “˜” is executed at a timing “00:00:00”. The command log “00:00:30 Is˜” indicates that a command to search for and display a file that matches the argument “˜” from the current folder is executed at a timing “00:00:30”. The command log “00:01:00 software Y stop” indicates that a command instructing the execution stop of the software Y is executed at a timing “00:01:00”.

The command log “00:02:00 command B” indicates that the command B is executed at a timing “00:02:00”. The command log “00:03:30 command C” indicates that the command C is executed at a timing “00:03:30”. The command log “00:05:00 software Y start” indicates that a command instructing the execution start of software Y is executed at a timing “00:05:00”.

With respect to the timing of the command log in FIG. 6, date is omitted, for the convenience of space in the drawings. Similarly, with respect to the command log in FIG. 6, the file path in the current directory (see FIG. 8) is omitted, for the convenience of space in the drawings.

FIG. 9 is a table of command logs, which is stored in a command log storage area R1 in FIG. 5. A command log table T1 has a command log ID field, an execution timing field, and a command field. The command log ID field stores an identifier of a command log that the command log obtaining unit 31 has acquired. The execution timing field stores the execution timing included in the command log that the command log obtaining unit 31 has acquired. The command field stores the contents (hereinafter, the contents of a command is referred to as a command as appropriate) of the executed command included in the command log that the command log obtaining unit 31 has acquired.

In the example of FIG. 9, when the first command log CML1 is obtained, the command log obtaining unit 31 stores an identifier “19001” of the first command log CML1 in the command log ID field. Then, the command log obtaining unit 31 stores the execution timing “Mon Nov 18 18:48:42.435 2013” of the first command log CML1 in the execution timing field. The command log obtaining unit 31 stores the command “cd/var/log” of the first command log CML1 in the command field.

The commands that are identified by the command log IDs “20001” to “20006” correspond to the command logs that are included in the first command log group CL1 in FIG. 6. In the following description of the table, “ . . . ” indicates omission. When the acquisition of the command log is ended, the analysis apparatus AN performs the acquisition of the file history in S2.

Next, the acquisition of the file history in S2 of FIG. 6 and FIG. 7 will be described with reference to FIG. 10 and FIG. 11. The information processing software PS of the server SVR receives a command transmitted from the user terminal USR, and executes a process corresponding to the received command. Through the execution of this process, the information processing software PS of the server SVR stores a newly created file in the storage device 202 of the server SVR, or updates or deletes the contents of the stored file.

The file history management software HS creates a file history of the file that is created, updated, or deleted through the execution of the information processing software PS, and stores the file history in the storage device 202. The file history of the file includes a date and time when the file is created, updated, and deleted, and a file path of the file that is created, updated, and deleted. Hereinafter, the date and time when the file is created, updated, and deleted is referred to as a time stamp of the file as appropriate. The timing may include date, hour, minute, and second.

For example, the information processing software PS of the server SVR updates a file (file name “messages”) stored in a folder indicated by a file path “/var/log” of the storage device 202, at 18 o'clock 48 minutes 35 seconds on Monday, Nov. 18, 2013. Then, the file history management software HS of the server SVR stores the update history of this file, as history information “[Mon Nov 18 18:52:35 2013]/var/log/messages”, in the storage device 202.

The file history of this file includes a time stamp “[Mon Nov 18 18:52:35 2013]” of the file, and the file path “/var/log/messages”.

The first management device MG1 to the k-th management device MGk similarly create file histories of files.

FIG. 10 is a diagram illustrating file histories of files. A file history group FH includes a first file history FHS1 to a third file history FHS3. The description of the first file history FHS1 is as described above, and thus it is omitted.

The second file history FHS2 includes a time stamp “[Mon Nov 18 00:05:02 2013]” of the file and a file path “/var/log/messages-20131117”. The third file history FHS3 includes a time stamp “[Mon Nov 18 18:51:12 2013]” of the file, and a file path “/var/log/messages-20131118”.

The file history obtaining unit 32 of the analysis apparatus AN requests the first server SVR1 to the m-th server SVRm to transmit the file history. The file history management software HS of the first server SVR1 to the m-th server SVRm transmits the file history stored in the storage device 202 to the analysis apparatus AN, in response to this request. The file history obtaining unit 32 of the analysis apparatus AN receives the file history, and allocates an identifier for identifying the received file history. The file history obtaining unit 32 associates and stores the received file history and the identifier of the received file history in the file history storage area R2.

As a method of obtaining the file history, there are other various methods. For example, a case is assumed in which the operating system OS of the first server SVR1 to the m-th server SVRm is UNIX (registered trademark). In this case, the file history obtaining unit 32 of the analysis apparatus AN transmits a command (for example, “Is” command) capable of obtaining a file path of a file and a time stamp of the file to the first server SVR1 to the m-th server SVRm.

When the operating system OS of the first server SVR1 to the m-th server SVRm receives this command, it transmits the time stamp of the file and the file path of the file to the file history obtaining unit 32 of the analysis apparatus AN in response to this command. The file history obtaining unit 32 receives the file history, and stores it in the file history storage area R2.

In the example of FIG. 6, the first file history group FH1 includes the first to third file histories. The first file history “00:02:01/var/opt/middle A/service.conf” includes a time stamp “[00:02:01]” of the file, and a file path “/var/opt/middle A/service.conf”.

The second file history “00:03:31/var/log/middle A/access.log” includes a time stamp “[00:03:31]” of the file, and a file path “/var/log/middle A/access.log”. The third file history “00:03:32/var/log/middle A/access1.log” includes a time stamp “[00:03:32]” of the file, and a file path “/var/log/middle A/access1.log”.

With respect to the time stamp of the file history in FIG. 6, date is omitted, for the convenience of a space in the drawing.

The file history obtaining unit 32 of the analysis apparatus AN may also request the first management device MG1 to the k-th management device MGk to transmit the file history. The first management device MG1 to the k-th management device MGk transmit the file history to the file history obtaining unit 32 of the analysis apparatus AN, in response to this transmission request.

FIG. 11 is a table of file histories, which is stored in the file history storage area R2 in FIG. 5.

A file history table T2 has a file history ID field, a time stamp field, and a file path field. The file history ID field stores an identifier of the obtained file history. The time stamp field stores a time stamp of the obtained file history. The file path field stores a file path of the obtained file history.

In the example of FIG. 11, when the file history obtaining unit 32 obtains the first file history FHS1, it stores the identifier “500012” of the first file history FHS1 in the file history ID field. The file history obtaining unit 32 stores the time stamp “[Mon Nov 18 18:52:35 2013” of the first file history FHS1 in the time stamp field. The file history obtaining unit 32 stores the file path “var/log/messages” of the first file history FHS1 in the file path field.

The file histories identified by the file history ID “600001” to “600003” correspond to the file histories included in the first file history group FH1 in FIG. 6. When the acquisition of the file histories is ended, the analysis apparatus AN executes the creation of the automation component in S3.

Next, the creation of the automation component in S3 of FIG. 6 and FIG. 7 will be described. The command log analysis unit 33 accesses all of the command logs stored in the command log storage area R1 (see FIG. 5), performs analysis of the command logs, and creates an automation component.

If any operational management work is performed, it is noted that commands are executed sequentially, and there is a predetermined pattern in the commands to be executed sequentially. The command log analysis unit 33 extracts the predetermined pattern and creates an automation component including a plurality of commands included in the predetermined pattern. In other words, the command log analysis unit 33 extracts an empirical rule such that a command has to be executed after a certain command is executed, and creates an automation component on the basis of the empirical rule.

Specifically, the command log analysis unit 33 detects a command sequence satisfying a predetermined condition. The predetermined condition includes the following first and second conditions. The first condition is that a probability (hereinafter, referred to as an execution probability as appropriate) of a certain command among commands in all of the command logs being executed after a reference command that is a reference for start is a predetermined percentage (%) or more. The second condition is that the number of executions of each command in a command sequence satisfying the first condition is equal to or greater than a predetermined number.

This execution probability is referred to as a probability a as appropriate, the predetermined percentage is referred to as X % as appropriate, and the predetermined number of times is referred to as Y as appropriate. The probability a is a value obtained by multiplying by 100 to a value obtained by dividing the execution count of a certain command by the execution count of the reference command. Here, an execution probability of the reference command is 100%.

The command log analysis unit 33 selects a command having an execution probability being X % or more and closest to X %, from a command sequence that has been detected. The command log analysis unit 33 identifies a command group including commands in a range of a reference command to a command that is executed following the selected command, from the command sequence that has been detected.

If identical command groups of a predetermined number or more are detected from the accessed command log, the command log analysis unit 33 creates an automation component including the identified command group. Below, the predetermined number is referred to as Z and the number of commands included in the identified command group is referred to as y, as appropriate. When the number y of commands included in the identified command group is a predetermined number or more, the command log analysis unit 33 may create an automation component including the identified command group.

A specific example of creation of an automation component will be described in detail with reference to FIG. 12. FIG. 12 is a diagram illustrating creation of an automation component. As illustrated in FIG. 12, it is assumed that a second command CM2 is executed after the execution of a first command CM1, and a third command CM3 is executed after the execution of the first command CM1 and the second command CM2. In addition, it is assumed that a fourth command CM4 is executed after the execution of the first command CM1, the second command CM2, and the third command CM3. In FIG. 12, a state where the series of commands CM1 to CM4 are executed is indicated by the arrows between the blocks.

The command log analysis unit 33 identifies the order in which respective commands are executed, by referring to the execution timing of the command included in the accessed command log. For example, a case is assumed in which the execution timing of the first command CM1 is t1, the execution timing of the second command CM2 is t2, and the execution timing t2 is later than the execution timing t1 (first assumption). In the case of the first assumption, since the execution timing t2 is later than the execution timing t1, the command log analysis unit 33 determines that the second command CM2 is executed after the execution of the first command CM1. When the execution timing t2 is later than the execution timing t1 and a difference (t2-t1) between the execution timings of both commands is within a predetermined period of time, the command log analysis unit 33 may determine that the second command CM2 is executed after the execution of the first command CM1.

Further, it is assumed that the first command CM1 is executed four times, the second command CM2 is executed three times after the first command CM1 is executed, and the third command CM3 is executed twice after the execution of the second command CM2 (second assumption).

In the second assumption, the first command CM1 is used as a reference command. The execution probability of the reference command CM1 is 100% (see “execution probability 100%” in FIG. 12).

The second command CM2 is executed three times after the first command CM1 is executed four times. Therefore, the probability a that the second command CM2 is executed after the reference command CM1 is 75% ((3/4)×100%) (see “execution probability 75%” in FIG. 12).

The third command CM3 is executed twice after the first command CM1 is executed four times. Therefore, the probability a that the third command CM3 is executed after the reference command CM1 is 50% ((2/4)×100%) (see “execution probability 50%” in FIG. 12). Here, it is assumed that X (%) described above is 70(%) and Y (times) is two (times).

From the above, the command log analysis unit 33 detects a command sequence as the first command CM1 and the second command CM2. Here, the command log analysis unit 33 selects the second command CM2 having a probability of 70% or more and closest to 70%, from the detected command sequence.

The command log analysis unit 33 identifies a command group including commands in a range of the reference command CM1 to the third command CM3 that is executed after the second command CM2. In the example of FIG. 12, the command log analysis unit 33 identifies the first command CM1 to third command CM3 as a command group. Here, it is assumed that Z described above is two.

It is assumed that the command log analysis unit 33 detects ten instances of the identified command group (the first command CM1 to third command CM3) from the accessed command logs. Since ten pieces is two (Z) or more pieces, the command log analysis unit 33 creates an automation component including the identified first command CM1 to the third command CM3 (see a frame of a dash-dot line in FIG. 12).

Here, the command log analysis unit 33 extracts the command sequence in a regular expression from the command log. In other words, to exclude the file path of the current directory (see FIG. 8), the command log analysis unit 33 excludes the character string, which is likely to indicate a file path of the current directory, between symbols. The character string between the symbol is a character string in the brackets “[ ]”. The command log analysis unit 33 regards a plurality of commands as identical commands and counts the number of executions when options and arguments of the plurality of commands match.

The method of creating an automation component described above is an example, and the creation of the automation component is possible by a variety of types of software (for example, “Chef”, “Capistrano”). Further, administrators and developers may create automation components manually.

The command log analysis unit 33 creates an automation component by executing the process illustrated in FIG. 12 on the plurality of obtained command logs. The command log analysis unit 33 stores the created automation component in the automation component storage area R7. In the example of FIG. 6, the command log analysis unit 33 creates the automation component AP1 including the commands of the first command log group CL1.

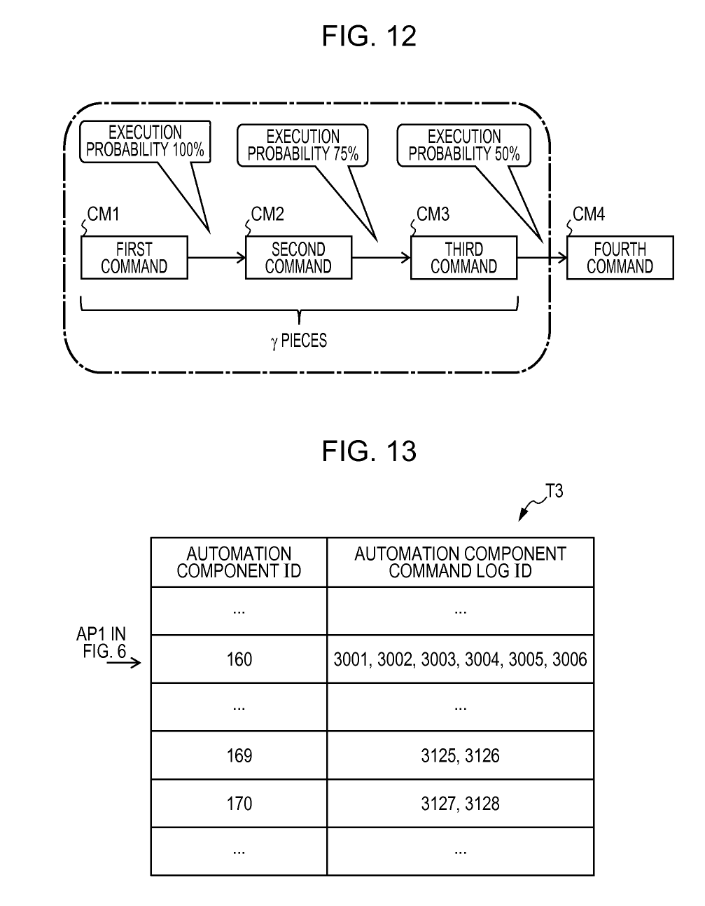

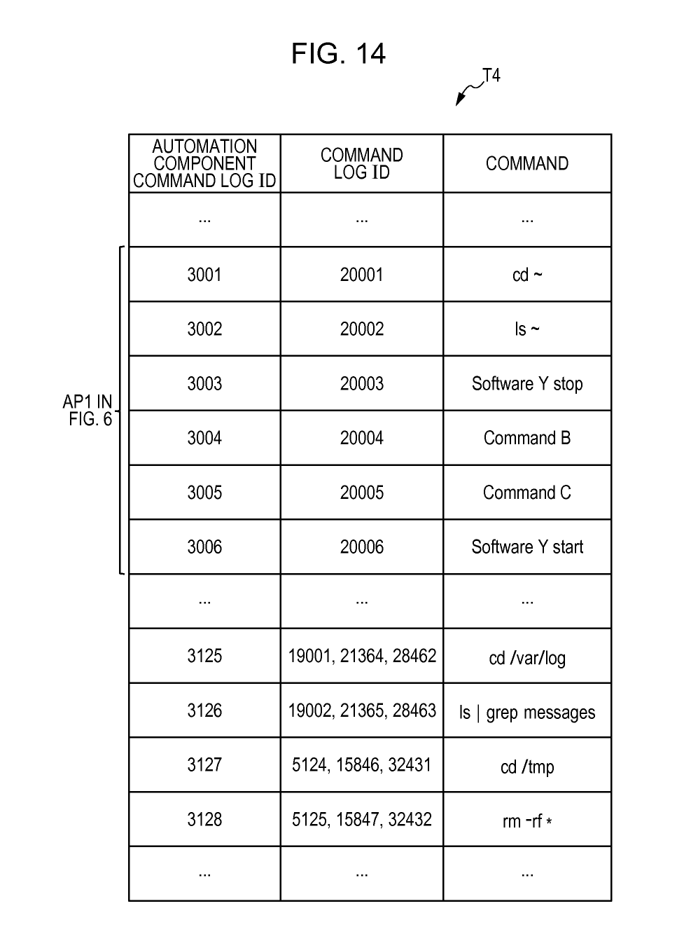

FIG. 13 and FIG. 14 are first and second tables of automation components that are stored in the automation component storage area R7 in FIG. 5.

A automation component table T3 of FIG. 13 has an automation component ID field and an automation component command log ID field. The automation component ID field stores an identifier of a created automation component. The automation component command log ID field stores identifiers of commands included in the automation component that is identified by the identifier in the automation component ID field.

When an automation component is created, the command log analysis unit 33 allocates an identifier for identifying the automation component, and stores it in the automation component ID field. The command log analysis unit 33 creates identifiers for identifying command logs of the commands included in the automation component, and stores them in the automation component command log ID field. An identifier for identifying a command log of a command included in the automation component has a one-to-one correspondence with the already allocated identifier of the command log.

When, for example, the automation component AP1 in FIG. 6 is created, the command log analysis unit 33 stores an identifier “160” of this automation component AP1 in the automation component ID field. The command log analysis unit 33 creates identifiers “3001” to “3006” having a one-to-one correspondence with the command log IDs “2001” to “2006” (see the command log ID field in FIG. 9) of the commands which are included in the automation component AP1. The command log analysis unit 33 stores the created identifiers “3001” to “3006” in the automation component command log ID field.

An automation component command log table T4 in FIG. 14 stores the identifier of the command log which is identified by the automation component command log ID in FIG. 13. The identifier of the command log is the command log ID stored in the command log ID field in FIG. 9.

The automation component command log table T4 has an automation component command log ID field, a command log ID field, and a command field. The automation component command log ID field stores an identifier that is stored in the automation component command log ID field in FIG. 13. The command log ID is a field for storing command log ID that is stored in the command log ID field in FIG. 9 and has a one-to-one correspondence with the identifier stored in the automation component command log ID field.

The command field is a field for storing a command included in the command log identified by the command log ID stored in the command log ID field.

For example, a case is assumed in which the automation component AP1 including the first command log group CL1 is created. In this case, the command log analysis unit 33 stores the command log IDs “20001” to “20006” (see the command log ID field in FIG. 9) for identifying the command logs included in the first command log group CL1, in the command log ID field in FIG. 14. The command log analysis unit 33 stores identifiers “3001” to “3006” having an one-to-one correspondence with the command log IDs “20001” to “20006”, respectively, in the automation component command log ID field in FIG. 14.

The command log analysis unit 33 stores commands that are included in the command logs identified by the command log IDs “20001” to “20006”, respectively, in the command field in FIG. 14.

By the above-described processing, the command log analysis unit 33 stores the created automation component in the automation component storage area R7 in FIG. 5 in a table format illustrated in FIG. 13 and FIG. 14. When the creation of automation component is ended, the analysis apparatus AN perform the extraction of a general-purpose command in S4.

Next, the extraction of a general-purpose command in S4 of FIG. 6 and FIG. 7 will be described with reference to FIG. 15 and FIG. 16. FIG. 15 is a flowchart illustrating an operation flow of extracting general-purpose commands in FIG. 6 and FIG. 7.

S41: The general-purpose command extraction unit 34 accesses all of the command logs which are stored in the command log storage area R1 (see FIG. 5). The general-purpose command extraction unit 34 creates exclusion commands obtained by excluding the options and the arguments of the commands extracted from all of the command logs, and stores them in the storage device 302.

In the example of FIG. 9, the general-purpose command extraction unit 34 creates an exclusion command “cd” obtained by excluding the argument “/var/log” from the command “cd/var/log”. In addition, in the example of FIG. 9, the general-purpose command extraction unit 34 creates an exclusion command “Is” obtained by excluding the argument “1 grep messages” from the command “Is|grep messages”.

The general-purpose command extraction unit 34 executes S41 for all of the obtained command logs, as illustrated by a loop from LP41s to LP41e. After the general-purpose command extraction unit 34 executes the processing of S41 on all of the obtained command logs, it proceeds to S42.

S42: The general-purpose command extraction unit 34 determines whether or not the exclusion command is a general-purpose command. If the exclusion command is a general-purpose command (S42/YES), it proceeds to S43. If the exclusion command is not a general-purpose command (S42/NO), the general-purpose command extraction unit 34 performs the determination process (S42) on an exclusion command for which the determination has not been performed.

S43: The general-purpose command extraction unit 34 extracts the exclusion command that has been determined as a general-purpose command, and stores it in the general-purpose command storage area R3 (see FIG. 5).

The general-purpose command extraction unit 34 executes S42 and after for all of the exclusion commands, as illustrated by a loop from LP42s to LP42e.

For example, the general-purpose command extraction unit 34 extracts, as a general-purpose command, a command having an occurrence frequency of the first occurrence frequency or more from the obtained command logs, and stores it in the general-purpose command storage area R3 (see FIG. 5). The first occurrence frequency is, for example, a first number of occurrences or a first occurrence ratio (described later).

For example, there are four types of methods of extracting a general-purpose command, in other words, a method of determining (S42) whether or not an exclusion command is a general-purpose command. The general-purpose command extraction unit 34 performs any of four methods described below, and extracts a general-purpose command.

In a first method, the number of occurrences of each exclusion command that is stored in the storage device 302 is counted after S41. If the counted number of occurrences of the exclusion command is a first occurrence count (for example, 10 times) or more, this exclusion command is determined as a general-purpose command. In the example of FIG. 9, for example, if the number of occurrences of the exclusion command “Is” is the first occurrence count or more, this exclusion command “Is” is determined as a general-purpose command.

In a second method, if the ratio (also referred to as an occurrence ratio) of the counted number of occurrences of an exclusion command relative to the number of all of the exclusion commands is a first occurrence ratio (for example, 0.2) or more, the exclusion command is determined as a general-purpose command. For example, it is assumed that the number of all of the exclusion commands is “100” and the counted number of occurrences of an exclusion command (for example, “Is” in FIG. 9) is “30” times. In this case, since the occurrence ratio of this exclusion command is 0.3(30/100), this occurrence ratio is the first occurrence ratio “0.2” or more. Therefore, the general-purpose command extraction unit 34 determines this exclusion command “Is” as a general-purpose command.

A third method uses a term frequency-inverse document frequency (tf-idf) method. In the third method, an index, which indicates how characteristic a character string of an exclusion command is, is obtained by using the tf-idf method. If an index indicating that the character string of the exclusion command is not characteristic is obtained, the general-purpose command extraction unit 34 determines this exclusion command as a general-purpose command. Since the tf-idf method is well known, a description thereof will be omitted.

In a fourth method, character strings (for example, “cd”, “Is”, “dir”, “ping”) and the like of commands that are commonly used as general-purpose commands are stored as target commands, in the storage device 302 of the analysis apparatus AN, and an exclusion command is compared to the target commands. If the exclusion command matches one of the target commands, this exclusion command is determined as a general-purpose command.

FIG. 16 is a table of general-purpose commands, which is stored in the general-purpose command storage area R3 in the FIG. 5.

A general-purpose command table T5 has a general-purpose command field. The general-purpose command extraction unit 34 stores a general-purpose command in the general-purpose command field of the general-purpose command table T5 (S43 of FIG. 15).

In the general-purpose command table T5, a general-purpose command (for example, such as “cd” and “Is” in FIG. 16) is stored in each line of the general-purpose command field. After the general-purpose commands are stored, the analysis apparatus AN performs the extraction of the common work command in S5.

Next, the extraction of the common work command in S5 of FIG. 6 and FIG. 7 will be described with reference to FIG. 17 and FIG. 18. FIG. 17 is a flowchart of a process of extracting common work commands in FIG. 6 and FIG. 7.

S51: The common work command extraction unit 35 excludes, from the commands extracted from all of the automation components stored in the storage device 302, the general-purpose commands extracted in S4. Below, the remaining commands which are obtained by excluding, from the commands extracted from all of the automation components stored in the storage device 302, the general-purpose commands extracted in S4 are referred to as common work candidate commands as appropriate.

Specifically, the common work command extraction unit 35 obtains commands stored in the command field of the automation component command log table T4 in FIG. 14 that are stored in the automation component storage area R7. Then, the common work command extraction unit 35 identifies, from the obtained commands, commands other than the general-purpose commands extracted in S4. The identified commands are common work candidate commands.

The common work command extraction unit 35 executes S51 for all of the automation components stored in the storage device 302, as illustrated by a loop from LP51s to LP51e. After the common work command extraction unit 35 executes S51 for all of the automation components stored in the storage device 302, it proceeds to S52. Alternatively, S51 may be omitted, and S52 and after may be executed for commands of all of the automation components. When performing the omission of this process, the commands of all of the automation components are described as the common work candidate commands.

S52: The common work command extraction unit 35 determines whether or not a common work candidate command is a common work command. If the common work candidate command is a common work command (S52/YES), the process proceeds to S53. If the common work candidate command is not a common work command (S52/N0), the common work command extraction unit 35 performs the determination process (S52) on a common work candidate command that is not determined yet.

S53: The common work command extraction unit 35 extracts the common work candidate command that is determined as a common work command, and stores it in the common work command storage area R4 (see FIG. 5).

The common work command extraction unit 35 executes S52 and after for all of the common work candidate commands, as illustrated by a loop from LP52s to LP52e.

For example, the common work command extraction unit 35 extracts, from the automation components obtained from the automation component storage area R7, a command having an occurrence frequency of a second occurrence frequency or more as a common work command, and stores it in the common work command storage area R4. The second occurrence frequency is, for example, a second number of occurrences or a second occurrence ratio (described later).

For example, there are four types of methods of extracting a common work command, in other words, a method of determining whether or not a common work candidate command is a common work command. The common work command extraction unit 35 performs any of four methods described below and extracts a common work command.

In a first method, the number of occurrences of each common work candidate command is counted after the general-purpose commands are excluded from among all the automation components which are stored in the storage device 302 (S51). If the counted number of occurrences of the common work candidate command is a second occurrence count (for example, 10 times) or more, the common work candidate command is determined as a common work command. In the example of FIG. 6, for example, if the number of occurrences of the common work candidate command “software Y stop” is the second occurrence count or more, the common work candidate command “software Y stop” is determined as a common work command.

In a second method, if the occurrence ratio of the counted number of occurrences of a common work candidate command relative to the number of all of the common work candidate commands is a second occurrence ratio or more, the common work candidate command is determined as a common work command. The second occurrence ratio is, for example, 0.2.

For example, it is assumed that the number of all of the common work candidate commands is “100” and the counted number of occurrences of a common work candidate commands (for example, “software Y stop” in FIG. 6) is “30” times. In this case, since the occurrence ratio of the common work candidate command is 0.3(30/100), this occurrence ratio is the second occurrence ratio “0.2” or more. Therefore, the common work command extraction unit 35 determines the common work candidate command “software Y stop” as a common work command.

A third method is a method using the tf-idf method. In the third method, an index, which indicates how characteristic a character string of a common work candidate command is, is obtained by using the tf-idf method. If an index indicating that the character string of the common work candidate command is not characteristic is obtained, the common work command extraction unit 35 determines the common work candidate command as a common work command.

In a fourth method, character strings (for example, “star”, “stop”, “restart”) and the like of commands that are commonly used as common work commands are stored in advance as target commands, in the storage device 302 of the analysis apparatus AN, and a common work candidate command is compared to the target commands. If the common work candidate command matches one of the target commands, the common work candidate command is determined as a common work command.

FIG. 18 is a table of common work commands, which is stored in a common work command storage area R4 in FIG. 5.

A common work command table T6 has a common work command field. The common work command extraction unit 35 stores a common work command in the common work command field of the common work command table T6 (S53 in FIG. 17).

In the common work command table T6, a common work command (for example, “/etc/init.d/httpd start”, “/etc/init.d/httpd start”, and the like in FIG. 18) is stored in each line in the common work command field. After the common work commands are stored, the analysis apparatus AN performs the association between the key command and the file history in S6.

Next, the association between the key command and the file history in S6 of FIG. 6 and FIG. 7 will be described with reference to FIG. 19 and FIG. 20. FIG. 19 is a diagram illustrating association between a key command and a file history. FIG. 19 illustrates the first command log group CL1 and the first file history group FH1 in FIG. 6. Here, the automation component AP1 (see FIG. 6) includes commands of the command logs included in the first command log group CL1.

The history association unit 36 extracts key commands by excluding the general-purpose commands (see S4 in FIG. 7) and the common work commands (see S5 in FIG. 7) from the commands extracted from all of the automation components. It may be regarded that a general-purpose command is a command that has a great number of occurrences, that is performed in various processes, and that is not a command for specific software. Further, it may be regarded that a common work command is a command for executing a task that is common in each automation component, and is not a command for specific software. Thus, the commands obtained by excluding the general-purpose commands and the common work commands from the commands extracted from all of the automation components are regarded as key commands. Through this exclusion, the key commands are extracted at a high degree of accuracy.

The extraction of a key command will be described with reference to the example of FIG. 19. The history association unit 36 excludes the general-purpose commands from the commands extracted from the automation component AP1. The logs of the general-purpose commands are indicated by a rectangular frame of a dashed line. The history association unit 36 excludes the common work commands from among the commands extracted from the automation component AP1. The logs of the common work commands are indicated by a rectangular frame of dotted lines.

The history association unit 36 extracts commands obtained by excluding the general-purpose commands and the common work commands from the commands extracted from the automation component AP1. The extracted commands (command B and command C) are key commands. The logs of the key commands are indicated by a rectangular frame of solid lines. Then, the history association unit 36 obtains execution timings of the commands included in the automation component AP1.

A description will be given regarding processing of obtaining an execution timing of a command with reference to FIG. 9, FIG. 13, and FIG. 14. The history association unit 36 identifies automation component command log IDs stored in association with the automation component ID, by referring to the automation component table T3 in FIG. 13. For example, in the case of the automation component AP1 (the automation component ID of the automation component AP1 is “160”), the history association unit 36 identifies automation component command log IDs “3001” to “3006”.

Then, the history association unit 36 identifies the command log IDs “20001” to “20006” that are stored in association with the identified automation component command log IDs “3001” to “3006”, by referring to the automation component command log table T4 in FIG. 14.

Then, the history association unit 36 obtains execution timings of the commands which are stored in association with the identified command log IDs “20001” to “20006”, by referring to the command log table T1 in FIG. 9.

The history association unit 36 extracts a command log of a next command executed following an extracted key command, based on the timing information in the command logs. The history association unit 36 selects, from among the obtained file histories, a file history including a timing between a first timing that is included in the timing information in the command log of the key command and the second timing that is included in the timing information in the command log of the next command. The history association unit 36 associates and stores the selected file history and the extracted key command in the associated history storage area R5 in FIG. 5. The selected file history is a file history corresponding to the key command.

Specifically, the history association unit 36 selects a file history including a file stamp in a time range from a timing when the key command is executed until a timing when the next command to the key command is executed, for all of the commands included in the automation component. The history association unit 36 associates and stores the key command and the file history corresponding to the key command, that is, the selected file history, in the associated history storage area R5 in FIG. 5. In the following example, the history association unit 36 associates and stores the command log of the key command and the file history corresponding to the key command in the associated history storage area R5 in FIG. 5.

The file history is stored in the file history table T2 in FIG. 11. Therefore, by referring to the time stamp field of the file history table T2 in FIG. 11, the history association unit 36 may perform the selection of the file history.

In the example of FIG. 19, a time stamp of a file history FHb (“00:02:01/var/opt/middle A/service.conf”) is “00:02:01”. Therefore, in the example of FIG. 19, a file history including, as a file stamp, the timing between a timing “00:02:00” when the key command B is executed and the timing “00:03:30” when the next command (command C) of the key command B is executed is the file history FHb. The file history FHb is identified by a file history ID “600001” illustrated in FIG. 11.

Therefore, the history association unit 36 associates and stores the command log of the key command B and the file history FHb corresponding to the key command B in the associated history storage area R5. The correspondence is indicated by a dash-dot line LNK1.

In the example of FIG. 19, a time stamp of a file history FHc1 (“00:03:31/var/log/middle A/access.log”) is “00:03:31”. A time stamp of a file history FHc2 (“00:03:32/var/log/middle A/access1.log”) is “00:03:32”.

Therefore, in the example of FIG. 19, file histories including, as a file stamp, timings between a timing “00:03:30” when the key command C is executed and a timing “00:05:00” when the next command (software Y start) is executed are file histories FHc1 and FHc2.

The file history FHc1 is identified by a file history ID “600002” illustrated in FIG. 11. The file history FHc2 is identified by a file history ID “600003” illustrated in FIG. 11.

Therefore, the history association unit 36 associates and stores the command log of the key command C and the file histories FHc1 and FHc2 corresponding to the key command C, in the associated history storage area R5. The correspondence between the command log of the key command C and the file history FHc1 corresponding to the key command C is indicated by a dash-dot line LNK2. The correspondence between the command log of the key command C and the file history FHc2 corresponding to the key command C is indicated by a dash-dot line LNK3.

FIG. 20 is a table that stores association between a command log of a key command and a file history. An association table T7 in FIG. 20 has a command log ID field and a file history ID field.

The history association unit 36 stores a command log ID of a command log of a key command, in the command log ID field. The history association unit 36 stores a file history ID of a file history corresponding to the key command, in the file history ID field.

In the case of the example of FIG. 19, the history association unit 36 stores the command log ID “20004” of the key command B in the command log ID field in FIG. 20. The history association unit 36 stores the file history ID “600001” of the file history FHb corresponding to the key command B, in the file history ID field in FIG. 20. The history association unit 36 also stores the command log ID “20005” of the key command C in the command log ID field in FIG. 20. The history association unit 36 stores the file history IDs “600002” and “600003” of the file histories FHc1 and FHc2 corresponding to the key command C, in the file history ID field in FIG. 20.

The history association unit 36 performs association of the key command and the file history in S6, for all of the automation components. After the association is ended, the analysis apparatus AN performs the extraction of duplicate file history in S7.

Next, the extraction of duplicate file history in S7 of FIG. 6 and FIG. 7 will be described with reference to FIG. 21 and FIG. 22. A case is assumed where the administrator performs an identical process for software installed in the first server SVR1 to the m-th server SVRm (see FIG. 1) by using the first user terminal USR1 (see FIG. 1). Then, a file is modified by executing the same key command in the first server SVR1 to the m-th server SVRm.

In the above assumption, the information processing software PS in the first server SVR1 to the m-th server SVRm executes the same key command. Then, the file history management software HS in the first server SVR1 to the m-th server SVRm creates the file history of the file.

As a result, the analysis apparatus AN obtains the file histories of a plurality of files changed by executing the same key command. Then, the history association unit 36 of the analysis apparatus AN associates and stores the key command and a plurality of file histories having the same contents.

FIG. 21 is a diagram illustrating a state in which a key command and a plurality of file histories are associated and stored. The command B and the command C in FIG. 21 are key commands, and a state in which the command C is executed following the command B is indicated by a solid line arrow.

FIG. 21 illustrates a state in which the key command B and four file histories FHb are associated (see dash-dot lines). The file history FHb is “00:02:01/var/opt/middle A/service.conf”. Different identifiers are respectively allocated to the four file histories FHb.

FIG. 21 also illustrates a state in which the key command C and two file histories FHc1 corresponding to the key command C are associated (see dash-dot lines). Different identifiers are respectively allocated to the two file histories FHc1. In addition, a state is illustrated in which the key command C and one file history FHc2 corresponding to the key command C are associated (see a dash-dot line). In addition, a state is illustrated in which the key command C and one file history FHc3 corresponding to the key command C are associated (see a dash-dot line). The file history FHc3 is “00:03:31/var/log/middle A/access.log” and “00:03:32/var/log/middle A/access1.log”.

Here it is assumed that, even when the contents of a plurality of file histories do not completely match, the file histories are the same file history if the file paths included in the file histories match each other. This is because the characteristic word is selected from the words in the file path in the selection of the characteristic word in S8. Thus, it is useless (unnecessary) that a plurality of the same file histories is stored in association with the key command.

Thus, the associated history analysis unit 37 shrinks the same file history (also referred to as a duplicate file history) into a single file history. The associated history analysis unit 37 extracts a file path from the file history that is shrunk into one. Here, With respect to a file history that is not duplicated, the associated history analysis unit 37 extracts a file path from the file history that is not duplicated.

The associated history analysis unit 37 associates and stores the key command and the file path of the file history corresponding to the key command, in the selected path storage area R6 (see FIG. 5). In the following description, a file path of a file history corresponding to a command is referred to as a file path of a command as appropriate. For example, the file path of the file history FHb corresponding to the key command B is referred to as the file path of the key command B.

Next, a method of extracting a file path will be described. A first method is a method of extracting the same file path that is included in all of the file histories corresponding to one key command.

In the example of FIG. 21, the associated history analysis unit 37 extracts the following file path by performing the first method. The associated history analysis unit 37 extracts the same file path “/var/opt/middle A/service.conf”, from among all of the file histories FHb corresponding to the key command B. In the example of FIG. 6, this file path is indicated as the file path FP1.

A second method is a method of extracting a file path that has a predetermined number of occurrences or a file path that has a predetermined occurrence ratio or more, from all of the file histories corresponding to one key command. The occurrence ratio of the file path is a ratio of a number of occurrences of a certain file path to the number of all file paths, in all of the file histories corresponding to one key command. The predetermined number of occurrences and the predetermined occurrence ratio are empirically determined as appropriate by the administrator.

In the example of FIG. 21, for all of the file histories FHc1, FHc2, and FHc3 corresponding to the key command C, the total number of occurrences of the file path is 5. The file paths are the “/var/log/middle A/access.log” and “/var/log/middle A/access1.log”. In the example of FIG. 6, the file path “/var/log/middle A/access.log” is indicated as a file path FP2. In addition, in the example of FIG. 6, the file path “/var/log/middle A/access1.log” is indicated as a file path FP3.

In all of the file histories FHc1, FHc2, and FHc3, the number of occurrences of the file path “/var/log/middle A/access.log” is three, and the number of occurrences of the file path “/var/log/middle A/access1.log” is two.

Therefore, the occurrence ratio of the file path “/var/log/middle A/access.log” is 0.6(3/5), and the occurrence ratio of the file path “/var/log/middle A/access1.log” is 0.4(2/5).

The associated history analysis unit 37, as described above, calculates the number of occurrences of a file path and the occurrence ratio of the file path. Here, it is assumed that the above-described predetermined number of occurrences is “2” and the predetermined occurrence ratio is “0.2”. In this assumption, the associated history analysis unit 37 performs the second method and extracts two file paths from among all of the file histories FHc1, FHc2, and FHc3 corresponding to the key command C. The first file path is the “/var/log/middle A/access.log”, and the second file path is the “/var/log/middle A/access1.log”.

If there is no duplicate file history or the file history corresponding to the key command is not stored, the associated history analysis unit 37 does not perform the process of extracting the duplicate file history. The associated history analysis unit 37 associates and stores the key command and the file path of the key command in the selected path storage area R6 in FIG. 5 in a table format.

FIG. 22 is a table of key commands and file paths of the key commands, which is stored in the selected path storage area R6 in FIG. 5. A file path table T8 has an automation component command log ID field, and a file path field. The automation component command log ID field stores an identifier of a command log of a command that is included in an automation component. The file path field stores a file path of a key command that is included in a command log of the key command identified by the identifier stored in the automation component command log ID field.

The associated history analysis unit 37 stores an automation component command log ID of a command in the automation component command log ID field, and stores a file path of this command in the file path field.

In the example of FIG. 21, the file path of the key command B is “/var/opt/middle A/service.conf”. The file paths of the key command C are “/var/log/middle A/access.log” and “/var/log/middle A/access1.log”. The automation component command log ID of the key command B is “3004”, according to the automation component command log table T4 in FIG. 14. The automation component command log ID of the key command C is “3005”, according to the automation component command log table T4 in FIG. 14.

Therefore, the associated history analysis unit 37 stores the file path “/var/opt/middle A/service.conf” in association with the automation component command log ID “3004” of the key command B, as illustrated in the file path table T8 in FIG. 22. In addition, as illustrated in FIG. 22, the associated history analysis unit 37 stores two file paths in association with the automation component command log ID “3005” of the key command C. The two file paths are “/var/log/middle A/access.log” and “/var/log/middle A/access1.log”. The character string “NULL” in the file path table T8 in FIG. 22 indicates a state where there is no file path with respect to the command.

After the process of storing the file path is ended, the analysis apparatus AN performs the selection of the characteristic word from this file path in S8.

Next, the selection of the characteristic word in S8 of FIG. 6 and FIG. 7 will be described with reference to FIG. 23 and FIG. 24. The keyword analysis unit 38 analyzes a plurality of file paths of a key command. Usually, because there are a large number of file histories, a plurality of file paths may be stored for one of key command. In this analysis, the keyword analysis unit 38 calculates the occurrence frequency of each word that is included in the plurality of file paths, and selects a characteristic word from among the words in the file paths, based on the occurrence frequency of each word.

FIG. 23 is a flowchart of a process of selecting a characteristic word in FIG. 6 and FIG. 7.

S81: The keyword analysis unit 38 divides a file path of a key command that is included in an automation component at each symbol, that is, “/” (slash) or “.” (dot). The keyword analysis unit 38 extracts the names of the folders and the name of the file as words by excluding the symbols.

S82: The keyword analysis unit 38 counts the number of occurrences of each word.

The keyword analysis unit 38 executes S81 and S82 for each of the key commands that are included in each of the automation components, as illustrated by a loop from LP81s to LP81e and a loop from LP82s to LP82e.

Specifically, the keyword analysis unit 38 divides each file path stored in the file path field of the file path table T8 in FIG. 22 at “/” (slash) or “.” (dot) and separates each file path into each word (S81). Then, the keyword analysis unit 38 counts the number of occurrences of each word (S82).

The keyword analysis unit 38 executes S81 and S82 for key command in each automation component, and after the execution of S81 and S82 are ended for all of the automation components, the process proceeds to S83.

S83: The keyword analysis unit 38 calculates an evaluation value of each word included in each key command included in each automation component. For example, the keyword analysis unit 38 calculates an evaluation value of a word in such a manner that as the occurrence frequency of the word increases, the evaluation value increases. For example, the keyword analysis unit 38 assumes a value obtained by dividing the number of occurrences of a certain word by the total number of occurrences of all words as the evaluation value. The keyword analysis unit 38 may assume the number of occurrences of the word as the evaluation value.

S84: The keyword analysis unit 38 selects a characteristic word of a file path, based on the evaluation value, and stores the selected characteristic word in the storage device 302. When the keyword analysis unit 38 calculates an evaluation value of a word in such a manner that as the occurrence frequency of the word included in a file path increases, the evaluation value increases, it selects a word having the smallest evaluation value as a characteristic word of the file path.

The keyword analysis unit 38 executes S83 and S84 for each of the key commands that are included in each of all automation components, as illustrated by a loop from LP83s to LP83e and a loop from LP84s to LP84e.

Specifically, the keyword analysis unit 38 calculates an evaluation value for each word in each file path stored in the file path field of the file path table T8 in FIG. 22, and selects a characteristic word of the file path on the basis of the evaluation value of each word.

FIG. 24 is a diagram illustrating the selection of a characteristic word. In FIG. 24, the command B and the command C are key commands, and a solid line arrow indicates that the command C is executed following the command B. The correspondence between the command B and the file path FP1 (“/var/opt/middle A/service.conf”) of the command B is indicated by a dash-dot line arrow. The correspondence between the command C and the file path FP2 (“/var/log/middle A/access.log”) of the command C is indicated by a dashed arrow.

The keyword analysis unit 38 divides the file path FP1 (“/var/opt/middle A/service.conf”) into words (S81), and counts the number of occurrences of each word (S82). These words are “var”, “opt”, “middle A”, “service”, and “conf”. The keyword analysis unit 38 divides the file path FP2 (“/var/log/middle A/access.log”) into words (S81), and counts the number of occurrences of each word (S82). These words are “var”, “log”, “middle A”, “access”, and “log”. Each word in FIG. 24 is indicated by a rectangular frame of a dash-dot line.

The keyword analysis unit 38 executes S81 and S82 for the file paths of other key commands.

The keyword analysis unit 38 calculates an evaluation value of each word (S83). The evaluation value of each word is represented by the number in parentheses in the rectangular frame. For example, the evaluation value of the word “var” is “132”. The keyword analysis unit 38 selects a word having the lowest evaluation value in a file path as a characteristic word of the file path (S84).

In the example of FIG. 24, in the file path FP1, the evaluation value of the word “middle A” is lowest. Therefore, the keyword analysis unit 38 determines the characteristic word of the file path FP1 as “middle A”. In addition, in the example of FIG. 24, in the file path FP2, the evaluation value of the word “middle A” is lowest. Therefore, the keyword analysis unit 38 determines the characteristic word of the file path FP2 as “middle A”.

Various methods may be used as a method of selecting a characteristic word. For example, the keyword analysis unit 38 divides each file path stored in the file path field of the file path table T8 in FIG. 22 at “/” (slash) or “.” (dot), and separates each file path into each word (S81). An index, which indicates how characteristic a word is, is obtained by using the tf-idf method for each word included in a file path of a key command included in one automation component. If an index indicating that a word is characteristic, the keyword analysis unit 38 selects the word as a characteristic word.

The administrator may store in advance a non-characteristic word in the storage device 302. This non-characteristic word is a word (“opt”, “log”, or the like) that is commonly used as a folder name, or a word (“uninstall”, “install”, or the like) that is commonly used as a file name. The non-characteristic word is a word that is commonly used as a file extension (“ini”, “bin”, or “exe”). The keyword analysis unit 38 may select any of the remaining words obtained by excluding the non-characteristic words stored in the storage device 302 from the words in the file path (see S81), as the characteristic word.

The administrator may store in advance names that identify specific software (for example, a product name) in the storage device 302. If there is a name stored in the storage device 302 among the words in the file path (see S81), the keyword analysis unit 38 may select the name as the characteristic word.

After the selection of the characteristic word is ended for all of the file paths, the analysis apparatus AN performs processing of setting a characteristic word as a tag in the automation component in S9.

Next, the process of setting a characteristic word as a tag in the automation component in S9 of FIG. 6 and FIG. 7 will be described with reference to FIG. 25 and FIG. 26.

The tagging unit 39 associates and stores a key command and a characteristic word of the key command in the automation component storage area R7 in FIG. 5 in a table format. The characteristic word of the key command is a characteristic word of the file path of this key command.

FIG. 25 is a first table of key commands and characteristic words of the key commands, which is stored in the automation component storage area R7 in FIG. 5. A characteristic word table T9 is a table obtained by adding a characteristic word field on the right end of the automation component command log table T4 in FIG. 14.

The tagging unit 39 stores a characteristic word of a key command in the characteristic word field corresponding to the automation component command log ID of the key command, in the characteristic word table T9.

In the example of FIG. 24, the characteristic word of the key command B is “middle A”. Further, the automation component command log ID of the key command B is “3004”, according to the automation component command log table T4 in FIG. 14. Therefore, the tagging unit 39 stores the characteristic word “middle A” of the key command B, in the characteristic word field corresponding to the automation component command log ID “3004”.

In the example of FIG. 24, the characteristic word of the key command C is “middle A”. Further, the automation component command log ID of the key command C is “3005”, according to the automation component command log table T4 in FIG. 14. Therefore, the tagging unit 39 stores the characteristic word “middle A” of the key command C, in the characteristic word field corresponding to the automation component command log ID “3005”.

A character string “NULL” indicates that there is no characteristic word. For example, command “software Y stop” is a common work command, and a file path corresponding to the common work command is not stored. Therefore, there is no characteristic word of the command “software Y stop”, and the tagging unit 39 stores the character string “NULL” in the characteristic word field of the command “software Y stop”.

If two or more key commands are included in one automation component, the characteristic words of each key command may be different in some cases. For example, it is assumed a case where in the file path table T8 in FIG. 22, the file paths of the command C have “middle B” in place of “middle A”, that is, “/var/log/middle B/access.log” and “/var/log/middle B/access1.log”.

In this assumption, if the keyword analysis unit 38 performs the process of selecting the characteristic word in FIG. 23, “middle B” may be selected as the characteristic word of the command C.

FIG. 26 is a second table of key commands and characteristic words of the key command, which is stored in the automation component storage area R7 in FIG. 5. If the selection is performed, the tagging unit 39 stores the characteristic word “middle B” of the key command C, in the characteristic word field corresponding to the automation component command log ID “3005” of the command C, in a characteristic word table T10.

If different characteristic words are included in one automation component, the tagging unit 39 calculates a contained rate of each characteristic word, and stores the contained rate in association with each characteristic word. The contained rate is a value obtained by dividing the number of each characteristic word of one automation component by the total number of all the characteristic words of the one automation component. Thus, the tagging unit 39 sets a weighting factor for the characteristic word, depending on the contained rate of the characteristic word. If only the same characteristic word is included in one automation component, the contained rate of this characteristic word is “1.0”.

In the example of FIG. 26, the total number of all characteristic words in the automation component AP1 (commands of the first command log group CL1 in FIG. 6) is “2” (“middle A” and “middle B”). The number of the characteristic word “middle A” of the automation component AP1 is “1”, and the number of characteristic word “middle B” of the automation component AP1 is “1”. Therefore, the tagging unit 39 calculates the contained rate of the characteristic word “middle A” as “0.5” (1/2) and the contained rate of the characteristic word “middle B” as “0.5” (1/2).

The tagging unit 39 associates and stores a characteristic word and a contained rate of the characteristic word, in the characteristic word field of the characteristic word table T10 in FIG. 26. For example, as illustrated in the characteristic word table T10, the tagging unit 39 stores the contained rate “0.5” of the characteristic word “middle A” as “middle A (0.5)”, and the contained rate “0.5” of the characteristic word “middle B” as “middle B (0.5)”.

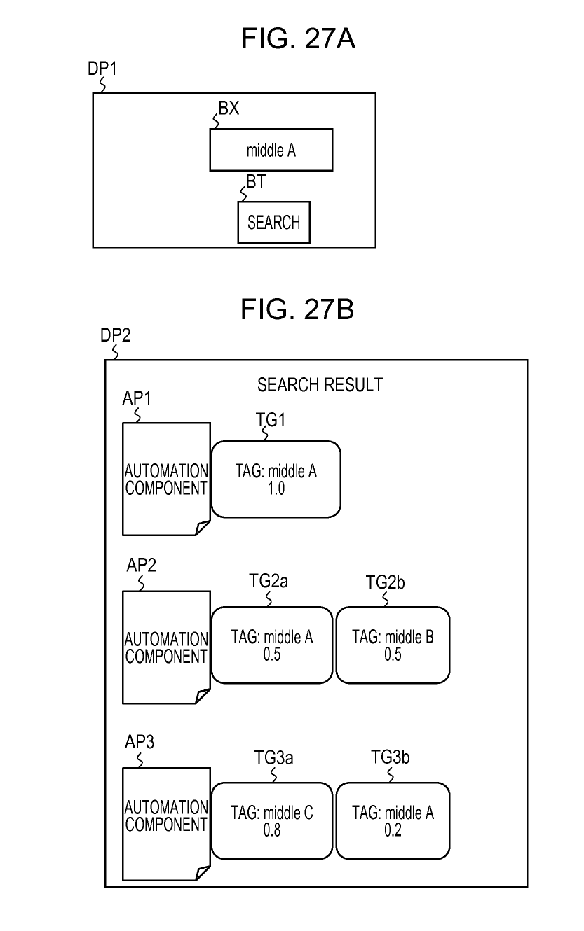

Next, a description will be given regarding search for an automation component with reference to FIGS. 27A and 27B. FIGS. 27A and 27B are diagrams illustrating search for an automation component. The administrator gives a search instruction to general-purpose software WS by operating the input device INP1 of the user terminal USR in FIG. 2. The search instruction is an instruction to search for an automation component for performing automation of operational management work for a desired software.

The general-purpose software WS displays a search instruction screen on a display device DSP1, in response to this search instruction. FIG. 27A illustrates an example of the search instruction screen. A search instruction screen DP1 includes a search box BX and a search button BT. Through the input device INP1, the administrator inputs the name of the desired software to the search box BX on the search instruction screen DP1 and clicks the search button BT. In the example of FIG. 27A, the name “middle A” of the desired software is input to the search box BX.

The general-purpose software WS transmits, to the analysis apparatus AN, a search instruction signal including the name “middle A” that is input to the search box BX, in response to this clicking. In other words, the name of the desired software is a characteristic word.

Upon receiving the search instruction signal, the search unit 40 of the analysis apparatus AN transmits, to the user terminal USR, a key command that is stored in association with the characteristic word of the search instruction signal in response to the received search instruction signal. Here, upon receiving the search instruction signal, the search unit 40 may transmit, to the user terminal USR, an automation component including the key command that is stored in association with the characteristic word of the search instruction signal in response to the received search instruction.

Specifically, upon receiving the search instruction signal, the search unit 40 searches for a key command for which the name “middle A” included in the search instruction signal is set as a characteristic word, from the automation component storage area R7 in FIG. 5. The search unit 40 also searches for an automation component including the found key command from the automation component storage area R7 in FIG. 5. It is assumed that, for example, the characteristic word table T9 in FIG. 25 is stored in the automation component storage area R7.

The search unit 40 finds the automation component command log IDs “3004” and “3005” which are stored in association with the characteristic word “middle A” from the characteristic word table T9 in FIG. 25. The search unit 40 identifies a cell including the automation component command log IDs “3004” and “3005”, from the automation component table T3 in FIG. 13, and obtains all of the automation component command log IDs that are included in this cell. All of the automation component command log IDs are “3001” to “3006”.

The search unit 40 obtains six commands that are stored in the characteristic word table T9 in FIG. 25 in association with the automation component command log IDs “3001” to “3006”. An automation component including the obtained six commands is the automation component AP1. The automation component AP1 is an automation component for performing automation of operational management work for the software (desired software) of the name “middle A”. The search unit 40 also obtains the key commands that are stored in association with the characteristic word “middle A”, from the characteristic word table T9 in FIG. 25.

It is assumed that the analysis apparatus AN creates an automation component AP2 (FIG. 27B) in S3 of FIG. 7 in addition to the automation component AP1, and selects “middle A” and “middle B” as characteristic words of the automation component AP2 in S8 of FIG. 7. The contained rates of the “middle A” and “middle B” are respectively “0.5”. It is also assumed that the analysis apparatus AN creates an automation component AP3 (FIG. 27B) in S3 of FIG. 7, and selects “middle C” and “middle A” as characteristic words of the automation component AP3 in S8 of FIG. 7. The contained rates of the “middle C” and “middle A” are respectively “0.8” and “0.2”.

The analysis apparatus AN transmits (outputs) the search results to the user terminal USR. The user terminal USR displays the search results on the display device DSP1. In the above example, the search results are the automation components AP1 to AP3, the key commands of the automation components AP1 to AP3, the characteristic words of each key command, and the contained rate of each characteristic word. The commands that are included in the automation components AP1 to AP3 are included in the search results.

FIG. 27B is an example of a search result screen that displays the automation components that are found by the search unit 40 of the analysis apparatus AN. The user terminal USR displays a search result screen DP2 on the display device DSP1.

In FIG. 27B, the automation component AP1 and a tag TG1 of the automation component AP1 are displayed. The tag TG1 indicates a tag (“middle A” “1.0”) of the automation component AP1. The numerical value that is included in the tag is the contained rate of the characteristic word (see FIG. 26). In addition, since the characteristic word of the automation component AP1 is only “middle A”, the contained rate is “1.0”.

In FIG. 27B, the automation component AP2 and tags TG2a and TG2b of the automation component AP2 are displayed. The tag TG2a indicates a tag (“middle A” “0.5”) of the automation component AP2. The tag TG2b indicates a tag (“middle B” “0.5”) of the automation component AP2.

In FIG. 27B, the automation component AP3 and tags TG3a and TG3b of the automation component AP3 are displayed. The tag TG3a indicates a tag (“middle C” “0.8”) of the automation component AP3. The tag TG3b indicates a tag (“middle A” “0.2”) of the automation component AP3.

As described in FIGS. 27A and 27B, the administrator may easily identify the automation components for performing automation of operational management work for the desired software, in the search result screen DP2. In addition, since characteristic words of a key command that is included in the automation components may be acquired, the administrator may easily identify a command for the desired software. In particular, if the characteristic word table T9 in FIG. 25 and the characteristic word table T10 in FIG. 26 are acquired from the analysis apparatus AN, the administrator may recognize a list of the key commands in which characteristic words are set.

When the automation components are created automatically by software, a large number of automation components may be created. In some cases, some of the automation components may operate incorrectly depending on the algorithm of the software. It is difficult for the administrator to identify the automation components for performing automation of operational management work for the desired software, by analyzing the large number of automation components one by one.

Even when an administrator (hereinafter, referred to as an administrator X) generates manually an automation component, since another administrator (hereinafter referred to as an administrator Y) does not create the automation component, the administrator Y does not know the contents of the automation component that has been created by the administrator X. For this reason, the administrator Y may identify the automation components for performing automation of operational management work for the desired software by analyzing the automation components one by one.

According to the present embodiment, a characteristic word representing specific software is set as a tag, in a key command of an automation component for performing automation of operational management work for the specific software. Therefore, for example, the administrator may easily identify the automation component for performing automation of operational management work for the desired software. As a result, the administrator may customize the automation component, and reduce the man-hours for implementing the further automation of operational management work for the desired software.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium having stored therein a program that causes a computer to execute a process, the process comprising:
obtaining a command history and a plurality of file histories, the command history including command logs of executed commands, the plurality of file histories each including timing information and a character string indicating a storage location of each file;
extracting key commands from the command history on basis of contents of the executed commands;
extracting first file histories corresponding to each of the key commands on basis of timing information included in a command log of each of the key commands and timing information included in the plurality of file histories;
storing the first file histories in association with a first key command corresponding to the first file histories;
selecting characteristic words from first character strings included in the first file histories; and
storing the characteristic words in association with the first key command.

2. The computer-readable recording medium according to claim 1, the process comprising:
extracting, on basis of occurrence frequencies of respective commands in the command history, general-purpose commands each including contents of a command for general use from the command history;
obtaining automation components each including a series of commands that are included in the command logs and automatically execute predetermined processes;
extracting common commands from the automation components on basis of occurrence frequencies of respective commands in the automation components, the common commands each including contents of a command which is common to two or more automation components; and
extracting the key commands by excluding the general-purpose commands and the common commands from commands included in the automation components.

3. The computer-readable recording medium according to claim 2, the process comprising:
extracting first commands having first occurrence frequencies in the command history, the first occurrence frequencies each being a first threshold value or more; and
storing the first commands as the general-purpose commands.

4. The computer-readable recording medium according to claim 3, the process comprising:
extracting second commands having second occurrence frequencies in the automation components, the second occurrence frequencies each being a second threshold value or more; and
storing the second commands as the common commands.

5. The computer-readable recording medium according to claim 2, wherein
timing information included in a command log of a specific command includes a timing at which the specific command is executed,
timing information included in a file history of a specific file includes a timing at which the specific file is changed, and
the process comprises:
extracting, on basis of timing information included in the command history, a first command log of a subsequent command which is executed succeeding to the first key command; and
selecting from the plurality of file histories, as the first file histories, file histories each including timing information which includes a timing between a first timing and a second timing, the first timing being included in timing information which is included in a command log of the second key command, the second timing being included in timing information which is included in the first command log.

6. The computer-readable recording medium according to claim 5, wherein
the character string includes a first name of a first file and second names of folders in which the first file is stored, and
the process comprises:
calculating first occurrence frequencies of respective first words included in the first character strings; and
selecting the characteristic words from the first words on basis of the first occurrence frequencies.

7. The computer-readable recording medium according to claim 6, wherein
the character string further includes a first symbol for separating the first name and one of the second names and second symbols for separating the second names from one another, and
the process comprises:
extracting, as the first words, the first name and the second names by excluding the first symbol and the second symbols from the first character strings.

8. The computer-readable recording medium according to claim 1, the process further comprising:
receiving a search instruction including a first characteristic word; and
outputting a key command that is stored in association with the first characteristic word.

9. The computer-readable recording medium according to claim 2, the process further comprising:
receiving a search instruction including a first characteristic word; and
outputting an automation component which includes a key command that is stored in association with the first characteristic word.

10. A command history analysis apparatus, comprising:
a memory device configured to
store therein a command history and a plurality of file histories, the command history including command logs of executed commands, the plurality of file histories each including timing information and a character string indicating a storage location of each file; and
a processor configured to
extract key commands from the command history on basis of contents of the executed commands,
extract first file histories corresponding to each of the key commands on basis of timing information included in a command log of each of the key commands and timing information included in the plurality of file histories,
store the first file histories in the memory device in association with a first key command corresponding to the first file histories,
select characteristic words from first character strings included in the first file histories, and
store the characteristic words in association with the first key command.

11. A command history analysis method, comprising:
obtaining, by a computer, a command history and a plurality of file histories, the command history including command logs of executed commands, the plurality of file histories each including timing information and a character string indicating a storage location of each file;
extracting key commands from the command history on basis of contents of the executed commands;
extracting first file histories corresponding to each of the key commands on basis of timing information included in a command log of each of the key commands and timing information included in the plurality of file histories;
storing the first file histories in association with a first key command corresponding to the first file histories;
selecting characteristic words from first character strings included in the first file histories; and
storing the characteristic words in association with the first key command.
